(19) United States
(12) Patent Application Publication
(10) Pub. No.: US 2023/0282877 A1
(43) Pub. Date: Sep. 7, 2023

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Shota OI, Kanagawa (JP); Yo KUSHIDA, Kanagawa (JP); Koji YASUDA, Kanagawa (JP)

(73) Assignee: FUJIFILM Corporation, Tokyo (JP)

(21) Appl. No.: 18/180,855

(22) Filed: Mar. 9, 2023

Related U.S. Application Data
(63) Continuation of application No. PCT/JP2021/035115, filed on Sep. 24, 2021.

(30) Foreign Application Priority Data
Sep. 30, 2020 (JP) 2020-166506

(51) Int. Cl. H01M 10/0562; H01M 10/0525

(52) U.S. Cl. CPC H01M 10/0562; H01M 10/0525; H01M 2300/0068

(57) ABSTRACT

There is provided an inorganic solid electrolyte-containing inorganic solid electrolyte-containing composition, a polymer binder, and a dispersion medium, where the polymer binder includes a polymer binder consisting of a random polymer that has a halogen atom directly connected to a main chain and has a content of non-aromatic carbon-carbon double bonds of 0.01 to 10 mmol/g. There are also provided a sheet for an all-solid state secondary battery and an all-solid state secondary battery, in which this inorganic solid electrolyte-containing composition is used, as well as manufacturing methods for a sheet for an all-solid state secondary battery, and an all-solid state secondary battery.

### CROSS-REFERENCE TO RELATED APPLICATIONS

This application is a Continuation of PCT International Application No. PCT/JP2021/035115 filed on Sep. 24, 2021, which claims priority under 35 U.S.C. § 119 (a) to Japanese Patent Application No. 2020-166506 filed in Japan on Sep. 30, 2020. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

A secondary battery is a storage battery that includes a negative electrode, a positive electrode, and an electrolyte between the negative electrode and the positive electrode and enables charging and discharging by the reciprocal migration of specific metal ions such as lithium ions between both electrodes.

Examples of the representative secondary battery include a secondary battery in which a gap between a negative electrode active material layer and a positive electrode active material layer is filled with a non-aqueous electrolyte such as an organic electrolytic solution. This non-aqueous electrolyte secondary battery exhibits relatively high battery performance and thus is used in a wide range of use applications. Such a non-aqueous electrolyte secondary battery is manufactured by various methods, and electrodes of the negative electrode active material layer and the positive electrode active material layer are generally formed of an electrode material containing an electrode active material, a binder, and a dispersion medium. For example, JP2014-011019A discloses a slurry for a secondary battery electrode, which contains a binder for a secondary battery electrode, containing an acid modification unit-containing block copolymer hydride, and contains an electrode active material, and dispersion medium, where the acid modification unit-containing block copolymer hydride is obtained by carrying out acid modification on a block copolymer hydride obtained by hydrogenating 90% or more of all unsaturated bonds of an [(A)-(B)-(A)] type block copolymer having a polymer block (A) containing a repeating unit derived from an aromatic vinyl compound as a main component and a polymer block (B) containing a repeating unit derived from a chain-like conjugated diene compound as a main component. In addition, JP2013-206598A discloses a positive electrode slurry that is a positive electrode slurry for a secondary battery, containing a positive electrode active material, a conductive agent, a binder, and a dispersion medium, where this binder contains a first polymer “containing a polymerization unit derived from vinylidene fluoride”, a second polymer containing “a polymerization unit having a nitrile group” and the like.

In the above-described non-aqueous electrolyte secondary battery, the non-aqueous electrolyte which is an organic electrolytic solution generally leakages easily, and a short circuit easily occurs in the inside of the battery due to overcharging or overdischarging. As a result, there is a demand for additional improvement in safety and reliability. Under these circumstances, an all-solid state secondary battery in which an inorganic solid electrolyte is used instead of the organic electrolytic solution has attracted attention. In this all-solid state secondary battery, since all of the negative electrode, the electrolyte, and the positive electrode are solid, safety and reliability that are considered as a problem of the non-aqueous electrolyte secondary battery can be significantly improved. It is also said to be capable of extending the battery life. Furthermore, all-solid state secondary batteries can be provided with a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, as substances that form constitutional layers (a solid electrolyte layer, a negative electrode active material layer, a positive electrode active material layer, and the like), solid materials such as an inorganic solid electrolyte and an active material are used. In recent years, this inorganic solid electrolyte, particularly an oxide-based inorganic solid electrolyte or a sulfide-based inorganic solid electrolyte is expected as an electrolyte material having a high ion conductivity comparable to that of the organic electrolytic solution. In consideration of improvement in productivity, a constitutional layer using such an inorganic solid electrolyte is generally formed of a material (a constitutional layer forming material) containing an inorganic solid electrolyte and a binder. However, since the electrode material of the non-aqueous electrolyte secondary battery does not contain an inorganic solid electrolyte, characteristics and the like thereof as a material for forming a constitutional layer of an all-solid state secondary battery have not been studied at all. On the other hand, as a constitutional layer forming material of an all-solid state secondary battery, for example, JP2013-033659A discloses a slurry containing a specific sulfide solid electrolyte material, a binding material which is a polymer having a double bond in a main chain, such as styrenebutadiene rubber, and a dispersion medium.

### SUMMARY OF THE INVENTION

Even in a case where such a material itself as described above exhibits high ionic conductivity, the interfacial contact state between solid particles is restricted in a case where a constitutional layer is formed of solid particles such as an inorganic solid electrolyte, an active material, or a conductive auxiliary agent. Therefore, the interface resistance easily increases (decrease in ion conductivity), and in an all-solid state secondary battery including a constitutional layer consisting of solid particles, the energy loss becomes large, and the cycle characteristics are deteriorated in a case where the battery is repeatedly charged and discharged. In addition, due to the restriction of the interfacial contact state, it is not possible to realize a sufficient binding force (adhesion) to the solid particles, the base material to be further laminated, and the like, and the cycle characteristics gradually deteriorate as charging and discharging are repeated.

Moreover, in recent years, the development for practical use of an all-solid state secondary battery has been rapidly progressing, and measures corresponding to this progress have been required. For example, the inorganic solid electrolyte has a unique problem in that it is easily deteriorated (decomposed) by water. In particular, from the viewpoint of industrial manufacturing, it is an important issue to suppress the deterioration during the manufacturing process. However, it is difficult to completely remove watery moisture in an environment including a manufacturing atmosphere even in consideration of the scale of the industrial manufacturing equipment and the like, and studies from the viewpoint of the constitutional layer forming material or the like are demanded. Further, from the viewpoints of productivity and production cost, the constitutional layer forming material is also required to have characteristics that can maintain the dispersibility of solid particles even in a case where the concentration of the solid particles is increased (even in a case where the solid content concentration is set to be high).

However, JP2013-033659A does not consider these viewpoints at all.

An object of the present invention is to provide an inorganic solid electrolyte-containing composition in which excellent dispersibility is exhibited and an inorganic solid electrolyte hardly deteriorates even in a case where the solid content concentration is increased, where the inorganic solid electrolyte-containing composition is capable of forming a low-resistance constitutional layer in which solid particles firmly adhere to each other. In addition, another object of the present invention is to provide a sheet for an all-solid state secondary battery as well as an all-solid state secondary battery, which include a constitutional layer formed of this inorganic solid electrolyte-containing composition, and manufacturing methods for a sheet for an all-solid state secondary battery and an all-solid state secondary battery, in which the above-described inorganic solid electrolyte-containing composition is used.

As a result of repeatedly carrying out various studies on a polymer binder in which an inorganic solid electrolyte and a dispersion medium were used in combination, the inventors of the present invention found that in a case where a polymer binder is formed of a random polymer in which a halogen atom is directly introduced (substituted) into a polymer main chain and then a non-aromatic carbon-carbon double bond is incorporated at a specific content into the molecule, it is possible to maintain the excellent dispersibility of the solid particles even in a case where the solid content concentration is increased, and moreover, it is possible to suppress the deterioration of the inorganic solid electrolyte due to watery moisture. In addition, it was found that in a case where the inorganic solid electrolyte-containing composition containing this specific polymer binder, inorganic solid electrolyte, and dispersion medium, is used as a constitutional layer forming material, it is possible to realize a sheet for an all-solid state secondary battery, having a constitutional layer which has low resistance and hardly deteriorates due to the firm binding of solid particles, as well as an all-solid state secondary battery having low resistance and excellent cycle characteristics as well. The present invention has been completed through further studies based on these findings.

That is, the above problems have been solved by the following means.

<1> An inorganic solid electrolyte-containing composition comprising:
an inorganic solid electrolyte having an ion conductivity of a metal belonging to Group 1 or Group 2 in the periodic table;
a polymer binder; and
a dispersion medium,
in which the polymer binder includes a polymer binder consisting of a random polymer that has a halogen atom directly connected to a main chain and has a content of non-aromatic carbon-carbon double bonds of 0.01 to 10 mmol/g.

<2> The inorganic solid electrolyte-containing composition according to <1>, in which the halogen atom includes a fluorine atom.

<3> The inorganic solid electrolyte-containing composition according to <1> or <2>, in which the polymer has a constitutional component represented by Formula (VF),

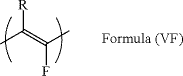

in Formula (VF), R represents a hydrogen atom or a substituent.

<4> The inorganic solid electrolyte-containing composition according to any one of <1> to <3>, in which the polymer binder consisting of the random polymer contains 0.01% to 1% by mass of an organic base.

<5> The inorganic solid electrolyte-containing composition according to any one of <1> to <4>, in which the random polymer has an oxygen atom or a sulfur atom, which is directly connected to the main chain.

<6> The inorganic solid electrolyte-containing composition according to any one of <1> to <5>, further comprising an active material.

<7> The inorganic solid electrolyte-containing composition according to any one of <1> to <6>, further comprising a conductive auxiliary agent.

<8> The inorganic solid electrolyte-containing composition according to any one of <1> to <7>, in which the polymer binder includes a polymer binder other than the polymer binder consisting of the random polymer.

<9> The inorganic solid electrolyte-containing composition according to any one of <1> to <8>, in which the inorganic solid electrolyte is a sulfide-based inorganic solid electrolyte.

<10> A sheet for an all-solid state secondary battery, comprising a layer formed of the inorganic solid electrolyte-containing composition according to any one of <1> to <9>.

<11> An all-solid state secondary battery comprising, in the following order:
a positive electrode active material layer;
a solid electrolyte layer; and
a negative electrode active material layer,
in which at least one of the positive electrode active material layer, the solid electrolyte layer, or the negative electrode active material layer is a layer formed of the inorganic solid electrolyte-containing composition according to any one of <1> to <9>.

<12> A manufacturing method for a sheet for an all-solid state secondary battery, the manufacturing method comprising forming a film of the inorganic solid electrolyte-containing composition according to any one of <1> to <9>.

<13> A manufacturing method for an all-solid state secondary battery, comprising manufacturing an all-solid state secondary battery through the manufacturing method according to <12>.

According to the present invention, it is possible to provide an inorganic solid electrolyte-containing composition in which excellent dispersibility is exhibited and an inorganic solid electrolyte hardly deteriorates even in a case where the solid content concentration is increased, where the inorganic solid electrolyte-containing composition is capable of forming a low-resistance constitutional layer in which solid particles firmly adhere to each other. In addition, according to the present invention, it is possible to provide a sheet for an all-solid state secondary battery and an all-solid state secondary battery, which include a layer formed of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type all-solid state secondary battery prepared in Examples.

### DESCRIPTION OF THE PREFERRED EMBODIMENTS

In the present invention, a numerical range indicated using “to” means a range including numerical values before and after the “to” as the lower limit value and the upper limit value.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one of or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it has the same meaning as a so-called polymeric compound. Further, a polymer binder consisting of a polymer means a binder constituted of a polymer and includes a polymer itself and a binder formed by containing a polymer.

### Inorganic Solid Electrolyte-Containing Composition

The inorganic solid electrolyte-containing composition according to the embodiment of the present invention contains an inorganic solid electrolyte having an ion conductivity of a metal belonging to Group 1 or Group 2 in the periodic table; a polymer binder; and a dispersion medium. A polymer binder contained in this inorganic solid electrolyte-containing composition contains one or two or more polymer binders (for convenience, may be referred to as a “halogenated binder”) constituted by containing a specific halogenated random polymer described later. That is, it suffices that the inorganic solid electrolyte-containing composition according to the embodiment of the present invention contains one or more halogenated binders as the polymer binder, and the content state of the halogenated binder and the like are not particularly limited. For example, in the inorganic solid electrolyte-containing composition, the halogenated binder may be or may not be adsorbed to the inorganic solid electrolyte.

The inorganic solid electrolyte-containing composition according to the embodiment of the present invention is preferably a slurry in which the inorganic solid electrolyte is dispersed in a dispersion medium. In the inorganic solid electrolyte-containing composition (in the dispersion medium), the halogenated binder has a function of dispersing solid particles such as the inorganic solid electrolyte (furthermore, an active material and a conductive auxiliary agent which are capable of being present together). The dispersion performance exhibited by the halogenated binder can be maintained even in a case where the solid content concentration of the solid particles is increased. The solid content concentration at this time is determined by the content of the dispersion medium described later. Since the inorganic solid electrolyte-containing composition according to the embodiment of the present invention contains the halogenated binder in combination with the inorganic solid electrolyte and the dispersion medium, the solid content concentration can also be increased. The solid content concentration is not uniquely determined by changing the composition temperature, the kind of the solid particles, and the like; however, it can be set to, for example, 40% by mass or more at 25° C. and more preferably 50% by mass or more.

In addition, the halogenated binder functions, in a constitutional layer formed of at least an inorganic solid electrolyte-containing composition, as a binder that causes solid particles to bind to each other (for example, between inorganic solid electrolytes, between an inorganic solid electrolyte and an active material, or between active materials). Further, it can function as a binder that binds a collector to solid particles. It is noted that in the inorganic solid electrolyte-containing composition, the halogenated binder may have or may not have a function of causing solid particles to bind to each other.

The inorganic solid electrolyte-containing composition according to the embodiment of the present invention has excellent dispersibility even in a case where the solid content concentration is increased, and thus the inorganic solid electrolyte is less likely to deteriorate. Since this inorganic solid electrolyte-containing composition is used as a constitutional layer forming material, it is possible to form a constitutional layer in which an inorganic solid electrolyte in which deterioration due to watery moisture is suppressed is firmly bound while an increase in interface resistance is suppressed, and thus it is possible to realize an all-solid state secondary battery having low resistance and excellent cycle characteristics.

In the aspect in which the active material layer formed on the collector is formed of the inorganic solid electrolyte-containing composition according to the embodiment of the present invention, it is also possible to strengthen the adhesiveness between the collector and the active material layer, and thus it is possible to achieve a further improvement of the cycle characteristics.

Although the details of the reason for the above are not yet clear, it is conceived to be as follows: the relationship (the interaction) between the solid particles such as the inorganic solid electrolyte and the binder in the constitutional layer forming material and the constitutional layer can be improved.

It is conceived that a polymer having a content of non-aromatic carbon-carbon double bonds of 0.01 to 10 mmol/g (a polymer binder containing the polymer) exhibits a suitable interaction with solid particles and adsorbs thereto. Therefore, in the inorganic solid electrolyte-containing composition, it is possible to improve the dispersibility of the solid particles with respect to the dispersion medium, and thus it is possible to maintain the excellent dispersibility of the solid particles even in a case where the solid content concentration is increased. In addition, in the constitutional layer, the solid particles are firmly bound to each other, and voids are hardly generated between the solid particles even by repeated charging and discharging (the constructed conduction path is hardly blocked), whereby cycle characteristics can be improved.

On the other hand, it is conceived that a halogenated polymer in which a halogen atom is directly introduced into the main chain (a halogenated binder containing the halogenated polymer) is repelled on the solid particles adsorbed due to the halogen atom and is scattered and precipitated on the surface thereof. Therefore, the direct contact between the solid particles (this contact is a contact that does not involve the halogenated binder and forms a conduction path) can be maintained without significantly impairing the firm binding force between the solid particles, and thus it is possible to suppress an increase in the interface resistance (suppress ion conduction) of solid particles. Further, the halogenated polymer repelled on the solid particles can effectively inhibit the contact of water with the inorganic solid electrolyte.

A halogenated random polymer, which has a halogen atom and a specific amount of double bonds and in which a constitutional component that forms the main chain thereof is randomly bonded, uniformly exhibits the action due to the halogen atom and the action due to the specific amount of double bonds over the entire halogenated binder, rather than locally as in a block polymer, thereby capable of achieving effects of both actions while harmonizing them in a well-balanced manner.

In this way, in the inorganic solid electrolyte-containing composition and the constitutional layer, it is possible to realize, with respect to the inorganic solid electrolyte, the suppression of the increase in resistance due to interfacial contact state and deterioration, the reinforcement of the binding force, and the like in a well-balanced manner. As a result, according to the inorganic solid electrolyte-containing composition according to the embodiment of the present invention, it is possible to form a low-resistance constitutional layer in which excellent dispersibility is exhibited, the inorganic solid electrolyte hardly deteriorates, and solid particles firmly adhere to each other even in a case where the solid content concentration is increased by using a halogenated binder in combination with the inorganic solid electrolyte and the dispersion medium. Therefore, in a case of using the inorganic solid electrolyte-containing composition according to the embodiment of the present invention as a constitutional layer forming material, it is conceived to be possible to realize a sheet for an all-solid state secondary battery, including a constitutional layer which has low resistance (has high conductivity) and hardly deteriorates due to the firm binding of solid particles, as well as an all-solid state secondary battery having low resistance and excellent cycle characteristics.

In a case where an active material layer is formed of the inorganic solid electrolyte-containing composition according to the embodiment of the present invention, the halogenated binder can be brought into contact with (closely adhere to) the surface of the collector in a state where the binder and the solid particles are dispersed. It is conceived that this makes it possible to realize the firm adhesiveness between the collector and the active material, whereby it is possible to further improve the cycle characteristics and the conductivity.

The inorganic solid electrolyte-containing composition according to the embodiment of the present invention is preferably used as a material (a constitutional layer forming material) for forming a solid electrolyte layer or an active material layer, where the material is for a sheet for an all-solid state secondary battery (including an electrode sheet for an all-solid state secondary battery) or an all-solid state secondary battery. In particular, it can be preferably used as a material for forming a negative electrode sheet for an all-solid state secondary battery or a material for forming a negative electrode active material layer, which contains a negative electrode active material having a large expansion and contraction due to charging and discharging, and high cycle characteristics and high conductivity can be achieved in this aspect as well.

The inorganic solid electrolyte-containing composition according to the embodiment of the present invention is preferably a non-aqueous composition. In the present invention, the non-aqueous composition includes not only an aspect including no watery moisture but also an aspect where the moisture content (also referred to as the “watery moisture content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value measured by carrying out filtration through a 0.02 µm membrane filter and then Karl Fischer titration.

The inorganic solid electrolyte-containing composition according to the aspect of the present invention includes an aspect containing not only an inorganic solid electrolyte but also an active material, as well as a conductive auxiliary agent or the like (the composition in this aspect may be referred to as the “electrode composition”).

Hereinafter, components that are contained and components that can be contained in the inorganic solid electrolyte-containing composition according to the embodiment of the present invention will be described.

### Inorganic Solid Electrolyte

The inorganic solid electrolyte-containing composition contains an inorganic solid electrolyte (it is also referred to as inorganic solid electrolyte particles in a case of having a particle shape).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

### (I) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Among the inorganic solid electrolytes, the sulfide-based inorganic solid electrolyte has a particularly high reactivity with water, and thus it is important to avoid contact with water (watery moisture) not only at the time of preparing the composition but also even in a case where the sulfide-based inorganic solid electrolyte has formed a constitutional layer. However, in the present invention, since it is used in combination with the above-described soluble binder, the deterioration of the sulfide-based inorganic solid electrolyte can be effectively prevented.

Examples of the sulfide-based inorganic solid electrolyte include a lithium ion-conductive inorganic solid electrolyte satisfying the composition represented by Formula (S1).

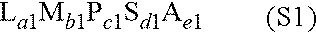

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li-P-S-based glass containing Li, P, and S or Li-P-S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li-P-S-based glass and Li-P-S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1 × 10⁻⁴ S/cm or more and more preferably set to 1 × 10⁻³ S/cm or more. The upper limit is not particularly limited but realistically 1 × 10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—Ge_{S}2—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—Si_{S}2—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This because treatments at a normal temperature become possible, and it is possible to simplify manufacturing processes.

### (Ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1 × 10⁻⁶ S/cm or more, more preferably 5 × 10⁻⁶ S/cm or more, and particularly preferably 1 × 10⁻⁵ S/cm or more. The upper limit is not particularly limited; however, it is practically 1 × 10⁻¹ S/cm or less.

Specific examples of the compound include LiₓₐLa_{ya}TiO₃ (LLT) [xa satisfies 0.3 ≤ xa ≤ 0.7, and ya satisfies 0.3 ≤ ya ≤ 0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5 ≤ xb ≤ 10, yb satisfies 1 ≤ yb ≤ 4, zb satisfies 1 ≤ zb ≤ 4, mb satisfies 0 ≤ mb ≤ 2, and nb satisfies 5 ≤ nb ≤ 20); Li_{xc}B_{yc}M^{cc}_{zc}O_{nc} (M^{cc} is one or more elements selected from C, S, Al, Si, Ga, Ge, In, and Sn, xc satisfies 0 < xc ≤ 5, yc satisfies 0 < yc ≤ 1, zc satisfies 0 < zc ≤ 1, and nc satisfies 0 < nc ≤ 6); Li_{xd}(Al, Ga)_{yd}(Ti, Ge)_{zd}Si_{ad}P_{md}O_{nd} (xd satisfies 1 ≤ xd ≤ 3, yd satisfies 0 ≤ yd ≤1, zd satisfies 0 ≤ zd ≤ 2, ad satisfies 0 ≤ ad ≤ 1, md satisfies 1≤ md ≤7, and nd satisfies 3 ≤ nd ≤ 13.); Li₍₃₋₂ₓₑ₎M^{ee}ₓₑD^{ee}O (xe represents a number between 0 and 0.1, and M^{ee} represents a divalent metal atom, D^{ee} represents a halogen atom or a combination of two or more halogen atoms); Li_{xf}Si_{yf}O_{zf} (xf satisfies 1 ≤ xf ≤ 5, yf satisfies 0 < yf ≤ 3, zf satisfies 1 ≤ zf ≤ 10); Li_{xg}S_{yg}O_{zg} (xg satisfies 1 ≤ xg ≤ 3, yg satisfies 0 < yg ≤ 2, zg satisfies 1 ≤ zg ≤ 10); Li₃BO₃; Li₃BO₃—Li₂SO₄,; Li₂O—B₂O₃—P₂O₅,; Li₂O—SiO₂,; Li₆BaLa₂Ta₂O₁₂; Li₃PO_{(4-3/2w)}N_{w} (w satisfies w < 1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0 ≤ xh ≤ 1, and yh satisfies 0 ≤ yh ≤ 1); and Li₇La₃Zr₂O₁₂ (LLZ) having a garnet-type crystal structure.

In addition, a phosphorus compound containing Li, P, or O is also desirable. Examples thereof include lithium phosphate (Li₃PO4); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

### (Iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

### (Iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄-LiCl.

The inorganic solid electrolyte is preferably particulate. In this case, the particle diameter (the volume average particle diameter) of the inorganic solid electrolyte is not particularly limited; however, it is preferably 0.01 µm or more and more preferably 0.1 µm or more. The upper limit is preferably 100 µm or less and more preferably 50 µm or less.

The particle diameter of the inorganic solid electrolyte is measured according to the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “particle diameter Analysis-Dynamic Light Scattering” as necessary. Five samples per level are produced and measured, and the average values thereof are employed.

The inorganic solid electrolyte-containing composition may contain one kind or two or more kinds of inorganic solid electrolytes.

The content of the inorganic solid electrolyte in the inorganic solid electrolyte-containing composition is not particularly limited. However, from the viewpoints of dispersibility and ion conductivity, it is preferably 50% by mass or more, more preferably 70% by mass or more, and still more preferably 90% by mass or more in 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described later, regarding the content of the inorganic solid electrolyte in the inorganic solid electrolyte-containing composition, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a component other than a dispersion medium described later.

### Polymer Binder

The inorganic solid electrolyte-containing composition according to the embodiment of the present invention contains a polymer binder and contains one or more kinds of halogenated binders described later as the polymer binder. The polymer binder contained in the inorganic solid electrolyte-containing composition according to the embodiment of the present invention may contain a polymer binder other than the halogenated binder, in addition to the halogenated binder.

### Halogenated Binder

The halogenated binder contained in the inorganic solid electrolyte-containing composition according to the embodiment of the present invention is formed by containing a halogenated random polymer having a halogen atom directly connected to the main chain and having a content of non-aromatic carbon-carbon double bonds of 0.01 to 10 mmol/g. That is, the halogenated random polymer is used as a polymer (also referred to as a binder forming polymer) that forms a polymer binder. In a case of using this halogenated binder in combination with an inorganic solid electrolyte and a dispersion medium, it is possible to prepare an inorganic solid electrolyte-containing composition in which excellent dispersibility is exhibited and an inorganic solid electrolyte hardly deteriorates even in a case where the solid content concentration is increased, and furthermore, it is possible to produce a constitutional layer which has low resistance and hardly deteriorates due to the firm binding of solid particles.

The halogenated binder may be formed by containing one or two or more of the above-described halogenated random polymers and may also contain another polymer and another component as long as the action of the above-described halogenated random polymer is not impaired.

The halogenated random polymer is a polymer in which two or more kinds of constitutional components are randomly bonded (polymerized). This makes it possible for the action due to each constitutional component to uniformly exhibit over the entire polymer as described above. In the halogenated random polymer, the bonding mode of the constitutional component that constitutes a polymerized chain included in the side chain is not particularly limited as long as the bonding mode of the constitutional component that constitutes the main chain of the halogenated random polymer (the polymerization mode of the polymer main chain) is random. The bonding mode of the side chain may be any one of block bonding, alternating bonding, or random bonding.

In the present invention, a main chain of the polymer refers to a linear molecular chain in which all the molecular chains that constitute the polymer other than the main chain can be conceived as a branched chain or a pendant with respect to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chains of the polymer refer to molecular chains other than the main chain and include a short molecular chain and a long molecular chain (a graft chain).

The halogenated random polymer has a halogen atom that is directly connected to the main chain thereof, specifically, a linear molecular chain (a molecular chain formed by polycondensation of a polycondensable functional group contained in a compound from which a constitutional component is derived) that constitutes the main chain. This halogen atom is bonded to the linear molecular chain without being liked through a linking group or the like, in other words, is bonded to an atom that constitutes the linear molecular chain. Since the halogen atom is directly connected to the main chain, the action of the halogen atom can be effectively exhibited.

The halogen atom that is directly connected to the main chain is not particularly limited, and examples thereof include atoms such as fluorine, chlorine, bromine, and iodine. A fluorine atom or a bromine atom is preferable in terms of the above-described action on solid particles and watery moisture, and a fluorine atom is preferable in terms of effectively exhibiting the above-described action on solid particles and water at a high level in a well-balanced manner.

The number of halogen atoms contained in the halogenated random polymer may be one or two or more, and the number of kinds of halogen atoms (refers to the number of kinds in terms of atoms, where the difference in chemical structure such as bonding position does not matter) contained in the halogenated random polymer may be one kind or two or more kinds. In a case where the halogenated random polymer has a plurality or a plurality of kinds of halogen atoms, the plurality or the plurality of kinds of halogen atoms may be of the same kind or different kinds. However, it is preferable that at least one halogen atom or one kind of halogen atom is a fluorine atom or a bromine atom, and it is more preferable that all halogen atoms or all kinds of halogen atoms are fluorine atoms.

The number of kinds and number of halogen atoms contained in one molecule of the halogenated random polymer vary depending on the mass average molecular weight, the kind or number of kinds of constitutional components, the content of the constitutional component, and the like, which are not uniquely determined but are appropriately determined in the present invention.

It suffices that the halogenated random polymer has a halogen atom that is directly connected to the main chain, and any one of the constitutional components that constitute the main chain may have a halogen atom. In the present invention, it is preferable that the random polymer has a halogen atom that is directly connected to the non-aromatic carbon-carbon double bond described later, that is, it has a constitutional component VX described later, from the viewpoint that the adhesiveness to solid particles can be further reinforced. It is noted that the halogenated random polymer may have a halogen atom in the side chain as long as it has a halogen atom that is directly connected to the main chain.

The halogenated random polymer has a non-aromatic carbon-carbon double bond. This makes it possible for the halogenated binder to exhibit a suitable interaction with solid particles. The carbon-carbon double bond (also simply referred to as a double bond) is a double bond that exhibits non-aromaticity and does not include a carbon-carbon double bond that constitutes an aromatic ring. Furthermore, it does not include an anti-aromatic carbon-carbon double bond either. Due to having a non-aromatic carbon-carbon double bond, the flexibility of the halogenated random polymer can be ensured, which reinforces the interaction with solid particles due to the double bond. The double bond contained in the halogenated random polymer may be a conjugated double bond linked through a single bond or may be a non-conjugated double bond as long as it exhibits non-aromaticity; however, a non-conjugated double bond is preferable.

It suffices that the halogenated random polymer has a double bond in any one of the main chain or the side chain, and the halogenated random polymer preferably has a double bond at least in the main chain from the viewpoint of effectively exhibiting the interaction with solid particles.

The content (abundance) of the double bond in the halogenated random polymer is 0.01 to 10 mmol per 1 g of polymer. In a case of setting the content of the double bond in the above range, it is possible to make the halogenated binder exhibit a suitable interaction with solid particles. In terms of dispersibility and adhesiveness of solid particles, the content of the double bond is preferably 0.05 to 8 mmol/g, more preferably 0.08 to 5 mmol/g, and still more preferably 0.1 to 3 mmol/g. The content of the double bond per 1 g of halogenated random polymer is a value calculated according to the method described in Example.

The halogenated random polymer preferably has an oxygen atom or a sulfur atom directly connected to the main chain. This makes it possible to inhibit excessive adhesion between solid particles and increase the dispersibility of the solid particles, and thus it is possible to increase the solid content concentration at which excellent dispersibility is exhibited. Here, the phrase that the oxygen atom or the sulfur atom is “directly connected” to the main chain has the same meaning as the above-described phrase that the halogen atom is directly connected to the main chain.

The oxygen atom or the sulfur atom, which is directly connected to the main chain, has a hydrogen atom or an organic group (including a polymerized chain), and specific examples thereof include an oxygen atom or a sulfur atom, which is contained R^{XC} of a constitutional component XC described later.

An organic base of preferably 0.01% to 2% by mass and more preferably 0.01% to 1% by mass is contained in the halogenated binder as another component that constitutes the halogenated binder. It is conceived that this makes the halogenated binder flexible, whereby the adhesiveness to solid particles can be further improved. The organic base is not particularly limited; however, examples thereof include a base catalyst that is used in a dehydrohalogenation reaction (a double bond introduction reaction) described later. The fact that the halogenated binder contains an organic base means that the halogenated binder is formed in a state (in a state of a mixture) where the halogenated random polymer and the organic base are mixed; however, a part of the organic base may be present (dissolved or discharged) in the dispersion medium or the constitutional layer. The mixing state or the bonding state between the halogenated random polymer and the organic base is not particularly limited. For example, the halogenated random polymer may contain the organic base, or an intermolecular interaction or a chemical bond may be formed between them.

In the present invention, the content of the organic base is still more preferably 0.05% to 0.8% by mass and particularly preferably 0.1% to 0.5% by mass in terms of the adhesiveness of solid particles. The content of the organic base in the halogenated random polymer is a value calculated according to the method described in Example.

The content of the organic base can be appropriately set by the using amount of the organic base to be used at the time of the synthesis of the halogenated binder (the dehydrohalogenation reaction or the like), the amount of the organic base mixed with the halogenated binder, and furthermore, the purification of the synthesized halogenated binder, and the like.

### Physical Properties, Characteristics, or Like of Halogenated Binder or Halogenated Random Polymer

In the present invention, it suffices that the halogenated random polymer as a binder forming polymer has the above-described structure or physical properties; however, it is preferable that a halogenated random polymer or a halogenated binder consisting of this halogenated random polymer further has the following physical properties, characteristics, or the like.

The halogenated binder may be soluble (a characteristic of being soluble) or insoluble in the dispersion medium contained in the inorganic solid electrolyte-containing composition; however, it is preferably a soluble type binder dissolved in the dispersion medium. Preferably, the halogenated binder in the inorganic solid electrolyte-containing composition is present in a state of being dissolved in a dispersion medium in the inorganic solid electrolyte-containing composition, which depends on the content thereof. Accordingly, the halogenated binder sufficiently functions to disperse solid particles in the dispersion medium, and the dispersibility of the solid particles in the inorganic solid electrolyte-containing composition can be improved. Further, it is possible to reinforce the adhesiveness between the solid particles or the adhesiveness to the collector, and it is also possible to enhance the effect of improving the cycle characteristics of the all-solid state secondary battery.

In the present invention, the description that a polymer binder is dissolved in a dispersion medium in an inorganic solid electrolyte-containing composition is not limited to an aspect in which the entire polymer binder is dissolved in the dispersion medium, and for example, a part of the polymer binder may be present in an insoluble form in the inorganic solid electrolyte-containing composition as long as the following solubility in a dispersion medium is 80% or more.

The measuring method for solubility is as follows. That is, a specified amount of a polymer binder as a measurement target is weighed in a glass bottle, 100 g of a dispersion medium that is the same kind as the dispersion medium contained in the inorganic solid electrolyte-containing composition is added thereto, and stirring is carried out at a temperature of 25° C. on a mix rotor at a rotation speed of 80 rpm for 24 hours. After stirring for 24 hours, the obtained mixed solution is subjected to the transmittance measurement under the following conditions. This test (the transmittance measurement) is carried out by changing the amount of the polymer binder dissolved (the above-described specified amount), and the upper limit concentration X (% by mass) at which the transmittance is 99.8% is defined as the solubility of the polymer binder in the above dispersion medium.

### Transmittance Measurement Conditions

Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

The watery moisture concentration of the halogenated binder (the halogenated random polymer) is preferably 100 ppm (in terms of mass) or less. In addition, the halogenated binder may be used by crystallizing and drying a polymer, or a solution or dispersion liquid of the halogenated binder may be used as it is.

The halogenated random polymer that forms the halogenated binder is preferably amorphous. In the present invention, the description that a polymer is “amorphous” typically refers to that no endothermic peak due to crystal melting is observed when the measurement is carried out at the glass transition temperature.

The halogenated random polymer that forms the halogenated binder may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the range described later at the start of use of the all-solid state secondary battery.

The mass average molecular weight of the halogenated random polymer is not particularly limited. It is, for example, preferably 15,000 or more, more preferably 30,000 or more, and still more preferably 50,000 or more. The upper limit thereof is practically 5,000,000 or less, preferably 4,000,000 or less, more preferably 3,000,000 or less, and still more preferably 500,000 or less.

### Measurement of Molecular Weight

In the present invention, unless specified otherwise, molecular weights of a polymer chain and a macromonomer refer to a mass average molecular weight and number average molecular weight in terms of standard polystyrene, which are determined by gel permeation chromatography (GPC). The measurement method thereof includes, basically, a method under Conditions 1 or Conditions 2 (preferential) described below. However, depending on the kind of polymer or macromonomer, an appropriate eluent may be suitably selected and used.

### Condition 1

Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive indicator (RI) detector

### Condition 2

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)
Carrier: tetrahydrofuran
Measurement temperature: 40° C.
Carrier flow rate: 1.0 ml/min
Sample concentration: 0.1% by mass
Detector: refractive indicator (RI) detector

### Halogenated Random Polymer

The kind, composition, and the like of the polymer in which a halogen atom is incorporated into the main chain are not particularly limited as long as the halogenated random polymer is a polymer that has a halogen atom directly connected to the main chain formed by randomly bonding two or more constitutional components and has a content of double bonds of 0.01 to 10 mmol/g. Examples of the kind of the polymer in which a halogen atom is incorporated into the main chain include sequential polymerization (polycondensation, polyaddition, or addition condensation) polymers such as polyurethane, polyurea, polyamide, polyimide, polyester, a polycarbonate resin, and a polyester resin; chain polymerization polymers such as a hydrocarbon polymer, a vinyl polymer, and (meth)acrylic polymer, and copolymerization polymers thereof.

In the present invention, as compared with those in which a halogen atom is incorporated into the main chain of the above-described various polymers, a so-called halogenated polymer (halogen-containing polymer) having a halogen atom that is directly connected to the main chain is preferable, and a halogenated polymer containing a constitutional component having a halogen atom directly connected to a linear molecular chain that constitutes the main chain (for convenience, also referred to as a “halogen directly connected constitutional component”) is more preferable. Examples of the halogen-containing polymer include a chlorine-containing polymer, a fluorine-containing polymer, and a bromine-containing polymer, where a fluorine-containing polymer is preferable.

Examples of the halogen-containing polymer suitable as the binder forming polymer include a polymer in which two or more kinds of constitutional components including a halogen directly connected constitutional component are randomly bonded, and suitable examples thereof include a random polymer containing a halogen directly connected constitutional component of, for example, 50% by mass or more.

The halogen directly connected constitutional component is not particularly limited as long as it is a constitutional component having a halogen atom directly connected to an atom that constitutes the linear molecular chain, and examples thereof include a constitutional component XV derived from a halogenated vinyl compound, a constitutional component VX having a halogen atom directly connected to a double bond, and furthermore, a constitutional component in which an oxygen atom or a sulfur atom is directly connected to the main chain (preferably, a constitutional component XC in which, in addition to a halogen atom, an oxygen atom or a sulfur atom is directly connected to the main chain). Hereinafter, each constitutional component will be described.

### Constitutional Component XV

The constitutional component XV is a constitutional component derived from a halogenated vinyl compound, and it is not particularly limited as long as it is a constitutional component derived from a halogenated vinyl compound. Examples of the halogenated vinyl compound include a polymerizable compound having a halogen atom directly bonded to a carbon atom that constitutes an ethylenically unsaturated group (a polymerizable group). Examples of such a polymerizable compound include ethylene halide, a halide of a vinyl compound (M2) described later, and a halide of a (meth)acrylic acid compound (M1) described later. In a case where the halogenated random polymer has the constitutional component XV, the deterioration due to watery moisture can be highly suppressed without impairing dispersibility and adhesiveness.

The constitutional component XV is preferably a constitutional component FV represented by Formula (FV).

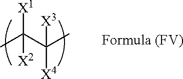

In Formula (FV), X¹ to X⁴ represent a hydrogen atom, a halogen atom, an alkyl group, or a halogenated alkyl group. However, at least one of X1, ..., or X⁴ is a halogen atom.

The halogen atom that can be adopted as X¹ to X⁴ has the same meaning as the above-described halogen atom that is directly connected to the main chain in the halogenated random polymer.

The alkyl group that can be adopted as X¹ to X⁴ is not particularly limited and may be any alkyl group that is linear, branched, or cyclic; however, it is preferably a linear or branched alkyl group. The number of carbon atoms that constitute the alkyl group is not particularly limited; however, it is preferably 1 to 20, more preferably 1 to 12, still more preferably 1 to 6, and particularly preferably 1 to 3.

The halogen atom and the alkyl group, which constitute the halogenated alkyl group that can be adopted as X¹ to X⁴, respectively have the same meanings as the halogen atom and the alkyl group, which can be adopted as X¹ to X⁴. The number of halogen atoms contained in the halogenated alkyl group is not particularly limited as long as it is 1 or more, and the entire alkyl group may be substituted with halogen atoms (a perhalogenoalkyl group). In the present invention, the halogenated alkyl group is preferably a fluoroalkyl group and more preferably a perfluoroalkyl group.

In the constitutional component FV, at least one of X¹, ..., or X⁴ is a halogen atom, where it is preferable that at least two of X¹ to X⁴ are a halogen atom, and it is more preferable that two thereof are a halogen atom. In a case where two or more halogen atoms are contained, any of X¹ to X⁴ may be a halogen atom; however, it is preferable that X¹ and X² or X³ and X⁴ are a halogen atom.

Preferred examples of the constitutional component XV include constitutional components derived from halogenated vinyl compounds such as monohalogenoethylene, vinylidene halide, trihalogenoethylene, tetrahalogenoethylene, and hexahalogenopropylene. It is noted that two or more halogen atoms may be the same or different from each other in a case of being contained. For example, tetrahalogenoethylene includes a compound in which all four halogen atoms are the same (tetrafluoroethylene or the like) and a compound in which one halogen atom is different (chlorotrifluoroethylene or the like).

From the viewpoints of dispersibility, adhesiveness, and suppression of deterioration, the constitutional component XV preferably contains vinylidene halide, tetrahalogenoethylene, hexahalogenopropylene, or the like, and it more preferably contains vinylidene fluoride, or tetrafluoroethylene, hexafluoropropylene.

### Constitutional Component VX

The constitutional component VX is a constitutional component having a halogen atom directly connected to a double bond, and it is preferably a constitutional component in which one carbon atom that forms a non-aromatic carbon-carbon double bond is substituted with a halogen atom. In a case where the halogenated random polymer has the constitutional component VX, the adhesiveness can be further reinforced while improving dispersibility and suppression of deterioration due to watery moisture.

Examples of the constitutional component VX include a constitutional component in which a fluorine atom in Formula (VF) is substituted with another halogen atom; however, a constitutional component VF represented by Formula (VF) is preferable from the viewpoint of exhibiting dispersibility, adhesiveness, and suppression of deterioration in a well-balanced manner.

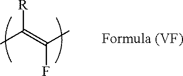

In Formula (VF), R represents a hydrogen atom or a substituent, where a hydrogen atom is preferable. The substituent that can be adopted as R is not particularly limited and appropriately selected from the substituent Z described later, where examples thereof include an alkyl group.

### Constitutional Component in Which Oxygen Atom or Sulfur Atom Is Directly Connected to Main Chain

A constitutional component, in which an oxygen atom or a sulfur atom is directly connected to the main chain and which is derived from a polymerizable compound having an oxygen atom or a sulfur atom, which is directly bonded to a carbon atom that constitutes an ethylenically unsaturated group (a polymerizable group), is preferably mentioned. In a case where the halogenated random polymer has this constitutional component, dispersibility of solid particles and the like can be improved. Examples of the constitutional component in which an oxygen atom or a sulfur atom is directly connected to the main chain include a constitutional component in which X in Formula (XC) below is an atom other than the halogen atom or a substituent appropriately selected from the substituent Z described later. A preferred one is the following constitutional component XC that further has a halogen atom that is directly bonded to an ethylenically unsaturated group.

### Constitutional Component XC

Preferred examples of the constitution XC include a constitutional component, in which, in addition to the halogen atom, an oxygen atom or a sulfur atom is directly connected to the main chain and which is derived from a polymerizable compound having a halogen atom that is directly bonded to a carbon atom that constitutes an ethylenically unsaturated group and having an oxygen atom that is directly bonded thereto or a sulfur atom. In a case where the halogenated random polymer has the constitutional component XC, it is possible to particularly inhibit excessive binding of the solid particles to each other, thereby improving dispersibility. In addition, the effects of the dispersibility, the adhesiveness, and the suppression of deterioration can be also maintained by reducing the content of the constitutional component VX.

The constitutional component XC is preferably a constitutional component represented by Formula (XC).

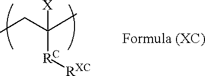

In Formula (XC), X represents a halogen atom. The halogen atom that can be adopted as X has the same meaning as the above-described halogen atom that is directly connected to the main chain in the halogenated random polymer.

R^{C} represents an oxygen atom or a sulfur atom.

R^{XC} represents a group containing a substituent or a polymerized chain. The substituent that can be adopted as R^{XC} is not particularly limited and is appropriately selected from the substituent Z described later. Among the above, a preferred one is a substituent capable of increasing the surface energy of the homopolymer consisting of the constitutional component XC as compared with the main chain of the halogenated random polymer. Specifically, the substituent that can be adopted as R^{XC} is preferably an alkyl group, a cycloalkyl group, an aryl group, a heterocyclic group, or an acyl group, and it is more preferably an alkyl group, a cycloalkyl group, or an aryl group. The alkyl group is, for example, preferably a long-chain alkyl group having 4 to 16 carbon atoms and more preferably a long-chain alkyl group having 6 to 14 carbon atoms from the viewpoint of the interaction with solid particles.

The substituent that can be adopted as R^{XC} may further have a substituent. Such a substituent is not particularly limited and may be appropriately selected from the substituent Z described later; however, it is preferably a hydroxy group, an aryl group, an amino group, or a carboxy group.

Examples of the group containing a polymerized chain that can be adopted as R^{XC} include a group containing a polymerized chain and a linking group that links this polymerized chain to R^{C}.

The polymerized chain is not particularly limited; however, a chain consisting of a general polymer such as the above-described polymer in which a halogen atom is incorporated into the main chain can be applied without particular limitation. In the present invention, a polymerized chain consisting of a (meth)acrylic polymer is preferable. The polymerized chain consisting of a (meth)acrylic polymer preferably has a constitutional component derived from the (meth)acrylic compound (M1) described later or a constitutional component derived from the vinyl compound (M2) described later. Among the above, it is more preferably a polymerized chain having a constitutional component derived from one or two or more (meth)acrylic acid ester compounds, and it is still more preferably a polymerized chain having a constitutional component derived from a (meth)acrylic acid alkyl ester compound and a constitutional component derived from a (meth)acrylic acid halogenoalkyl ester compound. The (meth)acrylic acid alkyl ester compound preferably includes an ester compound of a long-chain alkyl group having 4 or more carbon atoms and can further include an ester compound of a short-chain alkyl group having 3 or less carbon atoms. The content of each constitutional component in the polymerized chain is not particularly limited and is appropriately set. For example, the content of the constitutional component derived from the (meth)acrylic compound (M1) in the polymerized chain is, for example, preferably 30% to 100% by mass and more preferably 50% to 80% by mass. The content of the constitutional component derived from the (meth)acrylic acid alkyl ester compound is preferably 50% to 90% by mass and more preferably 60% to 80% by mass. In addition, the content of the constitutional component derived from the (meth)acrylic acid halogenoalkyl ester compound is preferably 5% to 50% by mass and more preferably 10% to 30% by mass. The total content of the content of the constitutional component derived from the (meth)acrylic acid alkyl ester compound and the content of the constitutional component derived from the (meth)acrylic acid halogenoalkyl ester compound is preferably within the range of the content of the constitutional component derived from the (meth)acrylic compound (M1).

In addition, in a case where a constitutional component derived from a (meth)acrylic acid long-chain alkyl ester compound and a constitutional component derived from a (meth)acrylic acid short-chain alkyl ester compound are contained, the content of the constitutional component derived from a (meth)acrylic acid long-chain alkyl ester compound can be set in the same range as the content of the constitutional component derived from the (meth)acrylic acid alkyl ester compound, described above, and the content of the constitutional component derived from a (meth)acrylic acid short-chain alkyl ester compound can be set in the same range as the content of the constitutional component derived from the (meth)acrylic acid halogenoalkyl ester compound described above.

The linking group is not particularly limited; however, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (-NR^{N}-: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group involved in the combination thereof. The linking group is preferably a group obtained by combining an alkylene group, an arylene group, a carbonyl group, an oxygen atom, a sulfur atom, and an imino group, more preferably a group obtained by combining an alkylene group, an arylene group, a carbonyl group, an oxygen atom, a sulfur atom, and an imino group. Preferred examples of the linking group also include a linking group including a structural part derived from a chain transfer agent (for example, 3-mercaptopropionic acid), a polymerization initiator, or the like, which is used in the synthesis of a compound from which the constitutional component XC is derived. Examples of the linking group include a linking group of the constitutional component XC contained in each of the polymers synthesized in Examples. The number of atoms that constitute the linking group and the number of linking atoms are as described below.

In the present invention, the number of atoms forming the linking group is preferably 1 to 36, more preferably 1 to 24, and still more preferably 1 to 12. The number of linking atoms of the linking group is preferably 10 or less and more preferably 8 or less. The lower limit thereof is 1 or more. The number of linking atoms refers to the minimum number of atoms linking predetermined structural parts. For example, in a case of —C(═O)—CH₂—CH₂—S—, the number of atoms that constitute the linking group is 9; however, the number of linking atoms is 4.

In Formula (XC), the carbon atom adjacent to the carbon atom to which X is bonded has two hydrogen atoms; however, in the present invention, it may have one or two substituents. This substituent is not particularly limited, and examples thereof include a substituent Z described later.

Specific examples of the constitutional component XC include the respective constitutional components contained in the exemplary polymer described below and the polymers synthesized in Examples, which are not limited in the present invention.

### Constitutional Component Other Than Halogen Directly Connected Constitutional Component

The halogenated random polymer may have a constitutional component other than the halogen directly connected constitutional component, for example, a constitutional component in which a halogen atom is not directly connected to an atom that constitutes the main chain of the polymer. Examples of such a constitutional component include a constitutional component derived from the (meth)acrylic compound (M1) and a constitutional component derived from the vinyl compound (M2).

Examples of the (meth)acrylic compound (M1) include a (meth)acrylic acid compound, a (meth)acrylic acid ester compound, a (meth)acrylamide compound, and a (meth)acrylonitrile compound, where a (meth)acrylic acid ester compound or a (meth)acrylonitrile compound is preferable.

Examples of the (meth)acrylic acid ester compound include a (meth)acrylic acid alkyl (excluding halogenoalkyl) ester compound, a (meth)acrylic acid halogenoalkyl ester compound, and a (meth)acrylic acid aryl ester compound, where a (meth)acrylic acid alkyl ester compound or a (meth)acrylic acid halogenoalkyl ester compound is preferable. The number of carbon atoms of the alkyl group that constitutes the (meth)acrylic acid alkyl ester compound is not particularly limited; however, it can be set to, for example, 1 to 24, and it is preferably 3 to 20, more preferably 4 to 16, and still more preferably 6 to 14. The number of carbon atoms of the alkyl group that constitutes the (meth)acrylic acid halogenoalkyl ester compound has the same meaning as that of the alkyl group that constitutes the (meth)acrylic acid alkyl ester compound. Regarding the halogenoalkyl group, a part of the hydrogen atoms may be substituted, or all the hydrogen atoms may be substituted (a perhalogenoalkyl group). Among the above, it is more preferable that the carbon atom on the terminal side of the halogenoalkyl group is substituted with halogen. For example, a halogenoalkyl group represented by the formula: CₙX₍₂ₙ₊₁₎ CₘH₍₂ₘ₎- is suitably included. In the formula, m is 1 or 2, and the total of n and m is the same as the number of carbon atoms of the halogenoalkyl group.

The number of carbon atoms of the aryl group that constitutes the aryl ester is not particularly limited; however, it can be set to, for example, 6 to 24, and it is preferably 6 to 10. In the (meth)acrylamide compound, the nitrogen atom of the amide group may be substituted with an alkyl group or an aryl group.

The vinyl compound (M2) is not particularly limited; however, it is preferably a vinyl compound that is copolymerizable with the (meth)acrylic compound (M1), where examples thereof include aromatic vinyl compounds such as a styrene compound, a vinyl naphthalene compound, and a vinyl carbazole compound, as well as an allyl compound, a vinyl ether compound, a vinyl ester compound, a dialkyl itaconate compound, and an unsaturated carboxylic acid anhydride, and a diene compound such as butadiene or isoprene. Examples of the vinyl compound include the “vinyl monomer” disclosed in JP2015-88486A. Among them, an aromatic vinyl compound or a diene compound is preferable, and a styrene compound or a butadiene compound is more preferable.

The (meth)acrylic compound (M1) and the vinyl compound (M2) may have a substituent. The substituent is not particularly limited, and examples thereof include a group selected from the substituent Z described later; however, regarding a carbon atom that constitutes an ethylenically unsaturated group, a substituent other than the halogen atom in the substituent Z shall be adopted.

The halogenated random polymer preferably has at least the constitutional component XV, more preferably has the constitutional component XV and the constitutional component VX from the viewpoint of exhibiting dispersibility, adhesiveness, and suppression of deterioration in a well-balanced manner, and still more preferably has the constitutional component XV, the constitutional component VX, and the constitutional component (preferably the constitutional component XC) in which an oxygen atom or a sulfur atom is directly connected to the main chain, from the viewpoint of further improving the dispersibility of the solid particles, and it is particularly preferable that all halogen atoms of the constitutional component XV, the constitutional component VX, and the constitutional component XC are fluorine atoms from the viewpoint that the dispersibility, the adhesiveness, and the suppression of deterioration can be balanced at a higher level.

The halogenated random polymer may have each of constitutional components of the constitutional component XV, the constitutional component VX, and the constitutional component in which an oxygen atom or a sulfur atom is directly connected to the main chain in any of the main chain and the side chain thereof. However, it is preferable that the main chain has.

The composition (the kind of constitutional component and the content thereof) of the halogenated random polymer is not particularly limited and is appropriately determined in consideration of the content of the double bond. For example, it is preferable to carry out the setting in the following range so that the total content of all the constitutional components becomes 100% by mass.

In the halogenated random polymer, the content of the halogen directly connected constitutional component is preferably 50% to 100% by mass, more preferably 60% to 100% by mass, and still more preferably 80% to 100% by mass.

Among the halogen directly connected constitutional components, the content of the constitutional component XV is preferably 40% to 100% by mass, more preferably 45% to 95% by mass, and still more preferably 50% to 90% by mass. The content of the vinylidene halide in the constitutional component XV is preferably 40% to 95% by mass, more preferably 45% to 95% by mass, and still more preferably 50% to 90% by mass. In addition, the content of the constitutional component VX is set in a range that satisfies the above-described content of the double bond per 1 g of polymer, and it is preferably 0.3% to 70% by mass, more preferably 0.4% to 60% by mass, and still more preferably 0.5% to 50% by mass, and it can be also set to 0.5% to 20% by mass. In a case where the halogenated random polymer contains the constitutional component XC, the content of the constitutional component VX can be reduced, and for example, it can be set to 0.03% to 1% by mass. The content of the constitutional component (preferably the constitutional component XC) in which an oxygen atom or a sulfur atom is further connected directly to the main chain is preferably 0% to 60% by mass, more preferably 5% to 50% by mass, and still more preferably 10% to 40% by mass. In the present invention, the total of the content of the constitutional component XV (the content of vinylidene halide), the content of the constitutional component VX, and the content of the constitutional component (preferably the constitutional component XC) in which an oxygen atom or a sulfur atom is directly connected to the main chain is preferably within the range of the above-described content of the halogen directly connected constitutional component.

In the halogenated random polymer, the content of the constitutional component derived from the (meth)acrylic compound (M1) is preferably 0% to 80% by mass and more preferably 0% to 70% by mass. Further, the content of the constitutional component derived from the vinyl compound (M2) can be set to 0% to 50% by mass, and it is preferably 10% to 30% by mass.

The content of the constitutional component that introduces a non-aromatic carbon-carbon double bond into the main chain of the halogenated random polymer is not particularly limited as long as the above-described content of the double bond per 1 g of polymer is satisfied. This constitutional component includes the constitutional component VX and a constitutional component derived from the vinyl compound (M2), and the contents of thereof are appropriately set within the range of the content of each constitutional component.

The halogenated random polymer (each constitutional component and raw material compound) may have a substituent. The substituent is not particularly limited; however, examples thereof preferably include a group selected from the following substituent Z.

### Substituent Z

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which an —O—CO— group is bonded to the above-described heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, or a nicotinoyloxy group); an aryloyloxy group (preferably an aryloyloxy group having 7 to 23 carbon atoms, for example, a benzoyloxy group or a naphthoyloxy group);a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphate group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

The binder forming polymer can be synthesized by selecting a raw material compound from which each constitutional component is derived and subjecting the raw material compound to polycondensation according to a known method.

The method of incorporating the constitutional component XV, the constitutional component VX, and the constitutional component (preferably the constitutional component XC) in which an oxygen atom or a sulfur atom is directly connected to the main chain, into the halogenated random polymer as a chain polymerization polymer, is not particularly limited. For example, the constitutional component VX can be incorporated into a polymer by subjecting a copolymer (the constitutional component XV) obtained by polymerizing a halogenated vinyl compound such as vinylidene halide as one of the raw material compounds to a dehydrohalogenation reaction to form a double bond. For the dehydrohalogenation reaction, a conventional method carried out in the presence of a base catalyst can be appropriately employed. The constitutional component in which an oxygen atom or a sulfur atom is directly connected to the main chain can be incorporated into the polymer by forming a double bond in the copolymer as described above and then subjecting this double bond to an addition reaction (for example, an ene reaction, an ene-thiol reaction, or an atom transfer radical polymerization (ATRP) method using a copper catalyst.

For dehydrofluorination reaction and addition reaction, general reaction methods and reaction conditions can be appropriately selected, and examples thereof include the methods and conditions shown in Examples. The dehydrofluorination reaction is preferably carried out in the presence of an organic base such as diazabicycloundecene, diazabicyclononene, or 1,1,3,3-tetramethylguanidine as a base catalyst from the viewpoint that flexibility can be imparted to the halogenated binder. The compound to be subjected to the addition reaction is not particularly limited as long as it can form a predetermined chemical structure, and examples thereof include a compound capable of constituting an R^{XC}-R^{C}- group in Formula (XC) by the addition reaction, examples of which includes each compound (including a polymer) of alcohol or mercapto, represented by R^{XC}-R^{C}-H.

Specific examples of halogenated random polymer include those shown below in addition to those synthesized in Examples; however, the present invention is not limited thereto. In each specific example, the number attached at the bottom right of the constitutional component indicates the content in the polymer, where the unit thereof is % by mass. It is noted that in the following specific examples, Ph represents a phenyl group, and Me represents a methyl group. In addition, * indicates a bonding site to a polymerized chain.

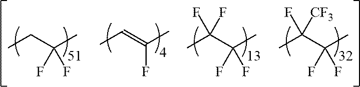

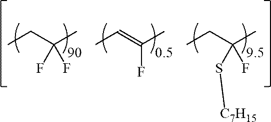

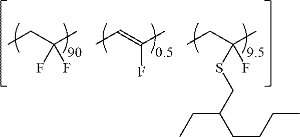

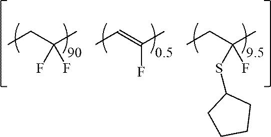

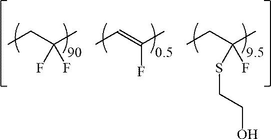

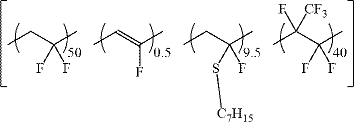

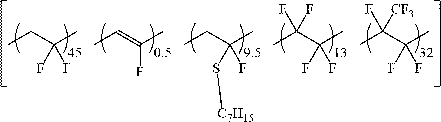

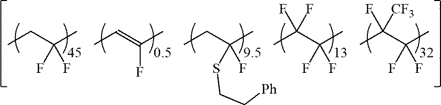

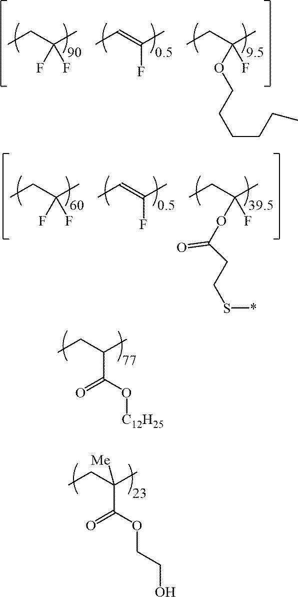

### Polymer Binder Other Than Halogenated Binder

The inorganic solid electrolyte-containing composition according to the embodiment of the present invention may contain one or more polymer binders other than the halogenated binder, as the polymer binder.

This polymer binder is a non-halogenated binder consisting of a polymer which does not have a halogen atom directly connected to the main chain, and examples thereof include a non-halogenated binder consisting of a polymer which does not have the above-described halogen directly connected constitutional component as a constitutional component.

As the non-halogenated binder, various polymer binders generally used for an all-solid state secondary battery can be appropriately selected and used. Examples thereof include the above-described sequential polymerization polymer and chain polymerization polymer (excluding a halogen-containing polymer), and copolymerization polymers thereof. Among them, polyurethane, polyurea, a hydrocarbon polymer, a vinyl polymer, a (meth)acrylic polymer, or the like is preferable, and a hydrocarbon polymer such as a styrene-ethylene-butylene-styrene block copolymer, polyurethane, or a (meth)acrylic polymer is more preferable.

The non-halogenated binder is preferably a particle-shaped binder (a particulate binder) which is insoluble in the dispersion medium of the composition. In a case where the inorganic solid electrolyte-containing composition contains a particle-shaped non-halogenated binder in addition to the halogenated binder, it is possible to improve the interfacial contact state of solid particles (suppress an increase in interface resistance) while maintaining the effect of improving the adhesiveness and dispersibility of solid particles due to the halogenated binder, which is preferable from the viewpoint that the cycle characteristics of the all-solid state secondary battery can be improved and the lower resistance can be further achieved (conductivity is further improved).

The shape of this particulate binder is not particularly limited and may be a flat shape, an amorphous shape, or the like; however, a spherical shape or a granular shape is preferable. The average particle diameter of the particulate binder is preferably 1 to 1,000 nm, more preferably 5 to 800 nm, still more preferably 10 to 600 nm, and particularly preferably 50 to 500 nm. The particle diameter can be measured in the same manner as in the measurement of the average particle diameter of the inorganic solid electrolyte. As the particulate binder, various particulate binders that are used in the manufacturing of an all-solid state secondary battery can be used without particular limitation. Examples thereof include a particulate binder consisting of the sequential polymerization polymer or the chain polymerization polymer (excluding a halogen-containing polymer), which are described above, and specific examples thereof include polymers B2-1 to B2-3, which are synthesized in Examples. In addition, other examples thereof include the binders disclosed in JP2015-088486A and WO2018/020827A.

In the inorganic solid electrolyte-containing composition according to the embodiment of the present invention, the total content of the polymer binder is not particularly limited; however, it is preferably 0.1% to 10.0% by mass, more preferably 0.3% to 9% by mass, still more preferably 0.5% to 8% by mass, and particularly preferably 0.7% to 7% by mass, in terms of dispersibility, adhesiveness, and suppression of deterioration, as well as conductivity. For the same reason, the total content of the polymer binder is preferably 0.1% to 10% by mass, more preferably 0.3% to 9% by mass, still more preferably 0.5% to 8% by mass, and particularly preferably 0.7% to 7% by mass in 100% by mass of the solid content.

In a case where the inorganic solid electrolyte-containing composition contains an active material, the total content of the binder in the composition is preferably 0.1% to 10% by mass, more preferably 0.2% to 5% by mass, still more preferably 0.3% to 4% by mass, and particularly preferably 0.5% to 2% by mass. For the same reason, the total content of the binder is preferably 0.1% to 20% by mass, more preferably 0.2% to 15% by mass, still more preferably 0.3% to 10% by mass, particularly preferably 0.5% to 5% by mass, and particularly preferably 0.5% to 4% by mass in 100% by mass of the solid content.

In the inorganic solid electrolyte-containing composition according to the embodiment of the present invention, the content of the halogenated binder is preferably 0.1% to 10% by mass, more preferably 0.2% to 5% by mass, and still more preferably 0.3% to 4% by mass, in terms of dispersibility, adhesiveness, and suppression of deterioration, as well as conductivity. For the same reason, the content of the halogenated binder in the inorganic solid electrolyte-containing composition is preferably 0.1% to 10% by mass, more preferably 0.3% to 8% by mass, and still more preferably 0.5% to 7% by mass, in 100% by mass of the solid content.

In the inorganic solid electrolyte-containing composition according to the embodiment of the present invention, the content of the non-halogenated binder is preferably 0.1% to 10% by mass, more preferably 0.2% to 5% by mass, and still more preferably 0.3% to 4% by mass, in terms of dispersibility, adhesiveness, and suppression of deterioration, as well as conductivity. For the same reason, the content of the non-halogenated binder in the inorganic solid electrolyte-containing composition is preferably 0.1% to 10% by mass, more preferably 0.3% to 8% by mass, and still more preferably 0.5% to 7% by mass, in 100% by mass of the solid content. It is noted that in a case where the non-halogenated binder is a particulate binder, the content of the particulate binder is appropriately set within the above range; however, it shall be preferably a content at which the particulate binder is not dissolved in the inorganic solid electrolyte-containing composition in consideration of the solubility of the particulate binder.

In a case where the inorganic solid electrolyte-containing composition contains a non-halogenated binder, the content of the non-halogenated binder may be higher than the content of the halogenated binder; however, it is preferable to be equal to or lower than the content of the halogenated binder. This makes it possible to further enhance conductivity without impairing excellent dispersibility, adhesiveness, and suppression of deterioration. The difference (in terms of absolute value) between the content of the non-halogenated binder and the content of the halogenated binder in 100% by mass of the solid content is not particularly limited, and it can be set to, for example, 0% to 6% by mass, more preferably 0% to 4% by mass, and still more preferably 0% to 2% by mass. In addition, the ratio of the content of the halogenated binder to the content of the non-halogenated binder (the content of the halogenated binder/the content of the non-halogenated binder) in 100% by mass of the solid content is not particularly limited; however, it is, for example, preferably 1 to 4 and more preferably 1 to 2.

In the present invention, the mass ratio [(the total mass of the inorganic solid electrolyte + the mass of the active material)/(the total mass of the binder)] of the total mass (the total amount) of the inorganic solid electrolyte and the active material to the total mass of the binder in 100% by mass of the solid content is preferably in a range of 1,000 to 1. Furthermore, this ratio is more preferably 500 to 2 and still more preferably 100 to 10.

### Dispersion Medium

It suffices that the dispersion medium contained in the inorganic solid electrolyte-containing composition is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally refers to a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The dispersion medium preferably has a boiling point of 50° C. or higher and more preferably 70° C. or higher at normal pressure (1 atm). The upper limit thereof is preferably 250° C. or lower and more preferably 220° C. or lower.

The inorganic solid electrolyte-containing composition may contain one kind or two or more kinds of dispersion media. Examples of the example thereof in which two or more kinds of dispersion media are contained include mixed xylene (a mixture of o-xylene, p-xylene, m-xylene, and ethylbenzene).

In the present invention, the content of the dispersion medium in the inorganic solid electrolyte-containing composition is not particularly limited and can be appropriately set according to the solid content concentration. For example, in the inorganic solid electrolyte-containing composition, it is preferably 20% to 80% by mass, more preferably 30% to 70% by mass, and particularly preferably 40% to 60% by mass. In a case of setting the solid content concentration to be high, it is possible to set the content of the dispersion medium to 50% by mass or less, 40% by mass or less, and furthermore 30% by mass or less. The lower limit thereof is not particularly limited; however, it can be, for example, 15% by mass.

### Active Material

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

### Positive Electrode Active Material

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide, an organic substance, or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, or V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{⅓}Co_{⅓}Mn_{⅓}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. The particle diameter (the volume average particle diameter) of the positive electrode active material is not particularly limited. For example, it can be set to 0.1 to 50 µm. The particle diameter of the positive electrode active material particle can be measured in the same manner as in the measurement of the particle diameter of the inorganic solid electrolyte. In order to allow the positive electrode active material to have a predetermined particle diameter, a general pulverizer or classifier is used. For example, a mortar, a ball mill, a sand mill, a vibration ball mill, a satellite ball mill, a planetary ball mill, a swirling air flow jet mill, or a sieve is preferably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material may be used singly, or two or more thereof may be used in combination.

The content of the positive electrode active material in the inorganic solid electrolyte-containing composition is not particularly limited; however, it is preferably 10% to 95% by mass, more preferably 20% to 90% by mass, still more preferably 30% to 80% by mass, and particularly preferably 40% to 70% by mass in 100% by mass of the solid content.

### Negative Electrode Active Material

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all -solid state secondary battery can be increased. In the constitutional layer formed of the solid electrolyte composition according to the embodiment of the present invention, solid particles firmly bind to each other, and thus a negative electrode active material capable of forming an alloy with lithium can be used as the negative electrode active material. As a result, it is possible to increase the capacity of the all-solid state secondary battery and extend battery life.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably amorphous oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “amorphous” represents an oxide having a broad scattering band with an apex in a range of 20° to 40° in terms of 2θ value in case of being measured by an X-ray diffraction method using CuKα rays, and the oxide may have a crystalline diffraction line. The highest intensity in a crystalline diffraction line observed in a range of 40° to 70° in terms of 2θ value is preferably 100 times or less and more preferably 5 times or less with respect to the intensity of a diffraction line at the apex in a broad scattering band observed in a range of 20° to 40° in terms of 2θ value, and it is still more preferable that the oxide does not have a crystalline diffraction line.

In the compound group consisting of the amorphous oxides and the chalcogenides, amorphous oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of the preferred amorphous oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with a amorphous oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of the cycle characteristics. However, since the inorganic solid electrolyte-containing composition according to the embodiment of the present invention contains the polymer binder described above, and thus it is possible to suppress the deterioration of the cycle characteristics. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon-containing active material in which the content of the silicon element is 50% by mole or more with respect to all the constitutional elements is more preferable.

In general, a negative electrode including the negative electrode active material (for example, an Si negative electrode including a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0 < x ≤ 1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. The particle diameter of the negative electrode active material is not particularly limited; however, it is preferably 0.1 to 60 µm. The particle diameter of the negative electrode active material particle can be measured in the same manner as in the measurement of the particle diameter of the inorganic solid electrolyte. In order to obtain the predetermined particle diameter, a typical pulverizer or classifier is used as in the case of the positive electrode active material.

The negative electrode active material may be used singly, or two or more negative electrode active materials may be used in combination.

The content of the negative electrode active material in the inorganic solid electrolyte-containing composition is not particularly limited, and it is preferably 5% to 90% by mass, more preferably 10% to 85% by mass, still more preferably 15% to 80% by mass, and even still more preferably 20% to 75% by mass in 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

### Coating of Active Material

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

### Conductive Auxiliary Agent

The inorganic solid electrolyte-containing composition according to the embodiment of the present invention preferably contains a conductive auxiliary agent, and for example, it is preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

One kind of conductive auxiliary agent may be contained, or two or more kinds thereof may be contained.

The shape of the conductive auxiliary agent is not particularly limited but is preferably a particle shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in 100% by mass of the solid content.

### Lithium Salt

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

### Dispersing Agent

Since the above-described polymer binder functions as a dispersing agent as well, the inorganic solid electrolyte-containing composition according to the embodiment of the present invention may not contain a dispersing agent other than this polymer binder; however, it may contain a dispersing agent. As the dispersing agent, a dispersing agent that is generally used for an all-solid state secondary battery can be appropriately selected and used. Generally, a compound intended for particle adsorption and steric repulsion and/or electrostatic repulsion is suitably used.

### Other Additives

As components other than the respective components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the binder forming polymer described above, a typically used binder, or the like may be contained.

### Preparation of Inorganic Solid Electrolyte-Containing Composition

The inorganic solid electrolyte-containing composition according to the embodiment of the present invention can be prepared by mixing an inorganic solid electrolyte, the above-described polymer binder, a dispersion medium, preferably a conductive auxiliary agent, and further appropriately a lithium salt, and any other optionally components, as a mixture and preferably as a slurry by using, for example, various mixers that are used generally. In a case of an electrode composition, an active material is further mixed.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser. Each component may be mixed collectively or may be mixed sequentially. A mixing environment is not particularly limited; however, examples thereof include a dry air environment and an inert gas environment. In addition, the mixing conditions are not particularly limited and are appropriately set.

### Sheet for All-Solid State Secondary Battery

A sheet for an all-solid state secondary battery according to the embodiment of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

In the present invention, each layer that constitutes a sheet for an all-solid state secondary battery may have a monolayer structure or a multilayer structure.

In the sheet for an all-solid state secondary battery, the solid electrolyte layer or the active material layer on the base material is formed of the inorganic solid electrolyte-containing composition according to the embodiment of the present invention. This sheet for an all-solid state secondary battery has a constitutional layer in which the deterioration of the inorganic solid electrolyte due to watery moisture is suppressed, and moreover solid particles including the inorganic solid electrolyte are firmly bound. As a result, the sheet for an all-solid state secondary battery according to the embodiment of the present invention can improve cycle characteristics of an all-solid state secondary battery and the low resistance (high conductivity) in a case where it is used as a solid electrolyte layer, an active material layer, or an electrode of an all-solid state secondary battery by appropriately peeling off a base material therefrom. In particular, in a case where an electrode sheet for an all-solid state secondary battery is incorporated into an all-solid state secondary battery as an electrode, the cycle characteristics can be further improved since an active material layer and a collector firmly adhere to each other.

It suffices that the solid electrolyte sheet for an all-solid state secondary battery according to the embodiment of the present invention is a sheet having a solid electrolyte layer, and it may be a sheet in which a solid electrolyte layer is formed on a base material or may be a sheet (a sheet from which the base material has been peeled off) that is formed of a solid electrolyte layer without including a base material. The solid electrolyte sheet for an all-solid state secondary battery may include another layer in addition to the solid electrolyte layer. Examples of the other layer include a protective layer (a stripping sheet), a collector, and a coating layer. Examples of the solid electrolyte sheet for an all-solid state secondary battery according to the embodiment of the present invention include a sheet including a layer formed of the inorganic solid electrolyte-containing composition according to the embodiment of the present invention, a typical solid electrolyte layer, and a protective layer on a base material in this order. The solid electrolyte layer included in the solid electrolyte sheet for an all-solid state secondary battery is preferably formed of the inorganic solid electrolyte-containing composition according to the embodiment of the present invention. The content of each component in the solid electrolyte layer is not particularly limited; however, it preferably has the same as the content of each component in the solid content of the inorganic solid electrolyte-containing composition according to the embodiment of the present invention. The layer thickness of each layer that constitutes the solid electrolyte sheet for an all-solid state secondary battery is the same as the layer thickness of each layer described later in the all-solid state secondary battery.

The base material is not particularly limited as long as it can support the solid electrolyte layer, and examples thereof include a sheet body (plate-shaped body) formed of materials described later regarding the collector, an organic material, an inorganic material, or the like. Examples of the organic material include various polymers, and specific examples thereof include polyethylene terephthalate, polypropylene, polyethylene, and cellulose. Examples of the inorganic materials include glass and ceramic.

It suffices that an electrode sheet for an all-solid state secondary battery according to the embodiment of the present invention (simply also referred to as an “electrode sheet”) is an electrode sheet including an active material layer, and it may be a sheet in which an active material layer is formed on a base material (collector) or may be a sheet (a sheet from which the base material has been peeled off) that is formed of an active material layer without including a base material. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. The content of each component in this solid electrolyte layer or active material layer is not particularly limited; however, it preferably has the same meaning as the content of each component in the solid content of the inorganic solid electrolyte-containing composition (the electrode composition) according to the embodiment of the present invention. The thickness of each of the layers forming the electrode sheet according to the embodiment of the present invention is the same as the layer thickness of each of the layers described later regarding the all-solid state secondary battery. The electrode sheet according to the embodiment of the present invention may include the above-described other layers.

In the sheet for an all-solid state secondary battery according to the embodiment of the present invention, at least one layer of the solid electrolyte layer or the active material layer is formed of the inorganic solid electrolyte-containing composition according to the embodiment of the present invention. Therefore, the sheet for an all-solid state secondary battery according to the embodiment of the present invention includes a constitutional layer in which the deterioration of the inorganic solid electrolyte due to watery moisture is suppressed and solid particles including the inorganic solid electrolyte are firmly bound and which has low resistance and hardly deteriorates. In a case of using this constitutional layer as a constitutional layer of an all-solid state secondary battery, it is possible to realize excellent cycle characteristics and excellent low resistance (high conductivity) of the all-solid state secondary battery. In particular, in the electrode sheet for an all-solid state secondary battery and the all-solid state secondary battery, in which the active material layer is formed of the inorganic solid electrolyte-containing composition according to the embodiment of the present invention, the active material layer and the collector exhibit strong adhesiveness, and thus it is possible to realize further improvement of the cycle characteristics.

It is noted that in a case where the sheet for an all-solid state secondary battery has a layer other than the active material layer or the solid electrolyte layer, which is formed by the manufacturing method for a sheet for an all-solid state secondary battery according to the embodiment of the present invention, a layer manufactured according to a conventional method using known materials can be used as this layer.

### Manufacturing Method for Sheet for All-Solid State Secondary Battery

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a base material or a collector (another layer may be interposed) to form a layer (a coated and dried layer) consisting of an inorganic solid electrolyte-containing composition. As a result, the sheet for an all-solid state secondary battery including the base material or the collector, and the coated and dried layer can be produced. In particular, in a case where a film of the inorganic solid electrolyte-containing composition according to the embodiment of the present invention is formed on a collector to produce a sheet for an all-solid state secondary battery, it is possible to strengthen the adhesion between the collector and the active material layer. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effect of the present invention is not impaired, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the base material, the protective layer (particularly stripping sheet), or the like can also be stripped.

### All-Solid State Secondary Battery

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. The positive electrode active material layer is preferably formed on a positive electrode collector to configure a positive electrode. The negative electrode active material layer is preferably formed on a negative electrode collector to configure a negative electrode.

At least one layer of the negative electrode active material layer, the positive electrode active material layer, or the solid electrolyte layer is formed of the inorganic solid electrolyte-containing composition according to the embodiment of the present invention, and at least one of the solid electrolyte layer, the negative electrode active material layer, or the positive electrode active material layer is preferably formed of the inorganic solid electrolyte-containing composition according to the embodiment of the present invention. The all-solid state secondary battery of the present invention, in which at least one layer of the constitutional layers is formed of the inorganic solid electrolyte-containing composition of the present invention, exhibits excellent cycle characteristics and high conductivity (low resistance).

In the present invention, an aspect in which all of the layers are formed of the inorganic solid electrolyte-containing composition according to the aspect of the present invention is also one of the preferred aspects. In the present invention, forming the constitutional layer of the all-solid state secondary battery by using the inorganic solid electrolyte-containing composition according to the embodiment of the present invention includes an aspect in which the constitutional layer is formed by using the sheet for an all-solid state secondary battery according to the embodiment of the present invention (however, in a case where a layer other than the layer formed of the inorganic solid electrolyte-containing composition according to the embodiment of the present invention is provided, a sheet from which this layer is removed).

In a case where the active material layer or the solid electrolyte layer is not formed of the inorganic solid electrolyte-containing composition according to the embodiment of the present invention, a known material in the related art can be used.

In the present invention, each constitutional layer (including a collector and the like) that constitutes an all-solid state secondary battery may have a monolayer structure or a multilayer structure.

### Positive Electrode Active Material Layer, Solid Electrolyte Layer, and Negative Electrode Active Material Layer

In the active material layer or the solid electrolyte layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention.

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 µm and more preferably 20 µm or more and less than 500 µm. In the all-solid state secondary battery according to the embodiment of the present invention, the thickness of at least one layer of the positive electrode active material layer or the negative electrode active material layer is still more preferably 50 µm or more and less than 500 µm.

Each of the positive electrode active material layer and the negative electrode active material layer may include a collector on the side opposite to the solid electrolyte layer.

### Collector

The positive electrode collector and the negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 µm. In addition, protrusions and recesses are preferably provided on the surface of the collector by carrying out a surface treatment.

### Other Configurations

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### Housing

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

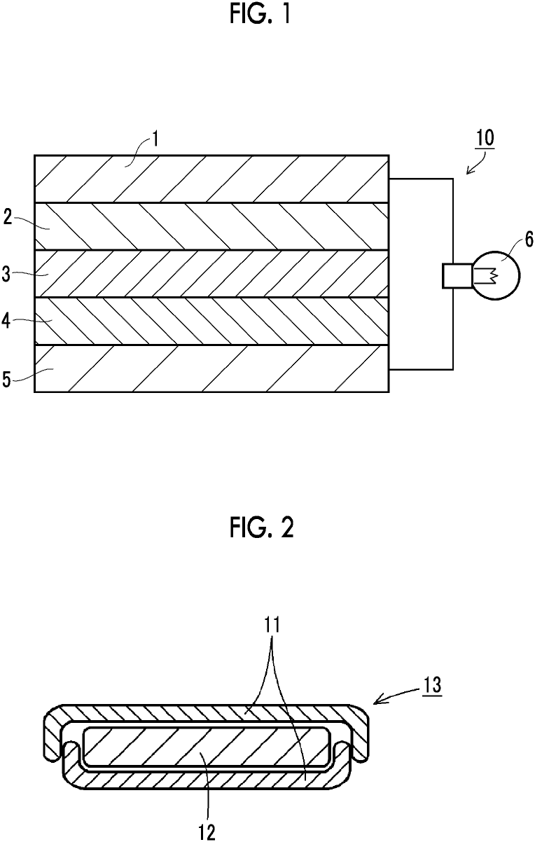

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is placed in a 2032-type coin case, the all-solid state secondary battery will be referred to as a laminate 12 for an all-solid state secondary battery, and a battery produced by placing this laminate 12 for an all-solid state secondary battery into a 2032-type coin case 11 (for example, a coin-type all-solid state secondary battery illustrated in FIG. 2) will be referred to as an all-solid state secondary battery 13, whereby both batteries may be distinctively referred to in some cases.

### Positive Electrode Active Material Layer, Solid Electrolyte Layer, and Negative Electrode Active Material Layer

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 exhibits excellent battery performance. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

The solid electrolyte layer contains an inorganic solid electrolyte having an ion conductivity of a metal belonging to Group 1 or Group 2 in the periodic table, the above-described polymer binder, and the above-described component within a range where the effect of the present invention is not impaired, and it generally does not contain a positive electrode active material and/or a negative electrode active material.

The positive electrode active material layer contains an inorganic solid electrolyte having an ion conductivity of a metal belonging to Group 1 or Group 2 in the periodic table, a positive electrode active material, the above-described polymer binder, and the above-described component within a range where the effect of the present invention is not impaired.

The negative electrode active material layer contains an inorganic solid electrolyte having an ion conductivity of a metal belonging to Group 1 or Group 2 in the periodic table, a negative electrode active material, the above-described polymer binder, and the above-described component within a range where the effect of the present invention is not impaired.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 µm regardless of the above thickness of the above negative electrode active material layer.

### (Collector)

The positive electrode collector 5 and the negative electrode collector 1 are as described above.

### Manufacture of All-Solid State Secondary Battery

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) which includes (is carried out through) a step of coating an appropriate base material (for example, a metal foil which serves as a collector) with the inorganic solid electrolyte-containing composition according to the embodiment of the present invention and forming a coating film (forming a film).

For example, an inorganic solid electrolyte-containing composition containing a positive electrode active material is applied as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Furthermore, an inorganic solid electrolyte-containing composition containing a negative electrode active material is applied as a material for a negative electrode (a negative electrode composition) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector as a base material and superposing a positive electrode collector thereon.

As another method, the following method can be exemplified. That is, the positive electrode sheet for an all-solid state secondary battery is produced as described above. In addition, in the same manner, an inorganic solid electrolyte-containing composition containing a negative electrode active material is applied as a material for a negative electrode (a negative electrode composition) onto a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this manner, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this manner, an all-solid state secondary battery can be manufactured. The pressurizing method and the pressurizing conditions in this method are not particularly limited, and a method and pressurizing conditions described in the pressurization step, which will be described later, can be applied.

The solid electrolyte layer or the like can also be formed on the base material or the active material layer, for example, by pressure-molding the inorganic solid electrolyte-containing composition or the like under a pressurizing condition described later, or the solid electrolyte or a sheet molded body of the active material.

In the above production method, it suffices that the inorganic solid electrolyte-containing composition according to the embodiment of the present invention is used in any one of the positive electrode composition, the inorganic solid electrolyte-containing composition, or the negative electrode composition. The inorganic solid electrolyte-containing composition according to the embodiment of the present invention is preferably used in the inorganic solid electrolyte-containing composition or at least one of the positive electrode composition or the negative electrode composition, or the inorganic solid electrolyte-containing composition according to the embodiment of the present invention can be used in any of the compositions.

In a case where the solid electrolyte layer or the active material layer is formed of a composition other than the inorganic solid electrolyte-containing composition according to the embodiment of the present invention, examples thereof include a typically used composition. In addition, the negative electrode active material layer can also be formed by binding ions of a metal belonging to Group 1 or Group 2 in the periodic table, which are accumulated on a negative electrode collector during initialization described later or during charging for use, without forming the negative electrode active material layer during the manufacturing of the all-solid state secondary battery to electrons and precipitating the ions on a negative electrode collector the like as a metal.

### Formation of Individual Layer (Film Formation)

The method of applying the inorganic solid electrolyte-containing composition is not particularly limited and can be appropriately selected. Examples thereof include wet-type coating methods such as spray coating, spin coating, dip coating, slit coating, stripe coating, and bar coating.

In this case, the inorganic solid electrolyte-containing composition may be subjected to drying treatment each time or may be subjected to drying treatment after being applied multiple times. The drying temperature is not particularly limited. The lower limit is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain a good binding property and a good ion conductivity even without pressurization.

In a case where the inorganic solid electrolyte-containing composition according to the embodiment of the present invention is applied and dried as described above, it is possible to suppress the variation in the contact state and bind solid particles, and furthermore, it is possible to form a coated and dried layer having a flat surface.

After applying the inorganic solid electrolyte-containing composition, it is preferable to pressurize each layer or the all-solid state secondary battery after superimposing the constitutional layers or producing the all-solid state secondary battery. Examples of the pressurizing methods include a method using a hydraulic cylinder press machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. It is also possible to carry out pressing at a temperature higher than the glass transition temperature of the polymer contained in the polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out transfer.

The atmosphere in the film forming method (coating, drying, and pressurization (under heating) is not particularly limited and may be any one of the atmospheres such as an atmosphere of dried air (the dew point: -20° C. or lower) and an atmosphere of inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

### Initialization

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

### Use Application of All-Solid State Secondary Battery

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

The polymers used in Examples and Comparative Examples are shown below. The number at the bottom right of each constitutional component indicates the content (% by mass). In the following polymers, Me represents a methyl group, and “*” or wavy lines in polymers B-7 and B2-1 indicate a bonding site to a polymerized chain.

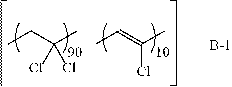

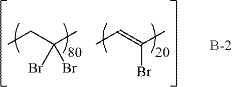

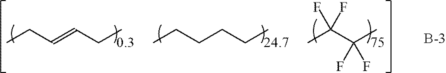

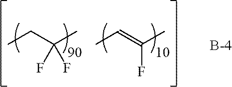

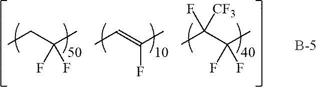

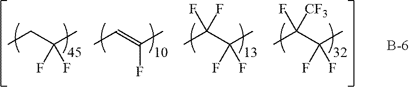

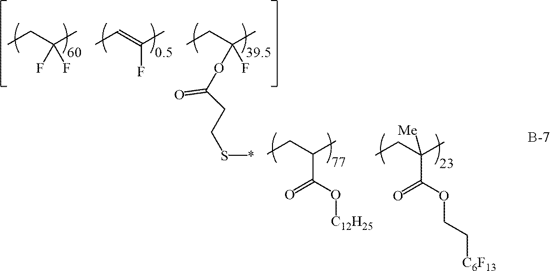

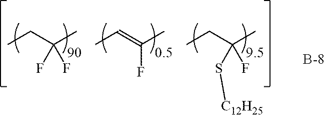

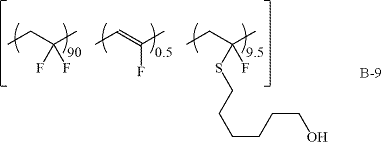

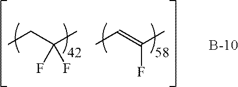

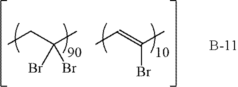

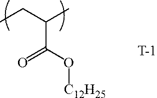

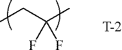

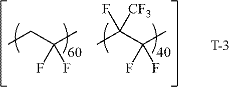

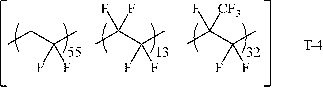

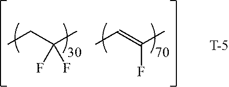

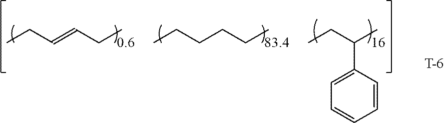

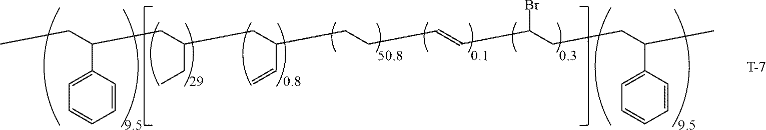

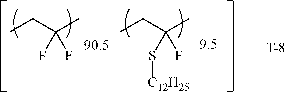

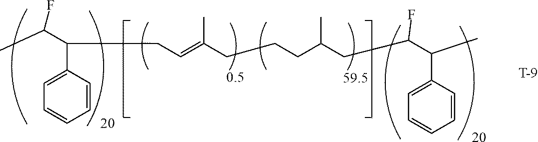

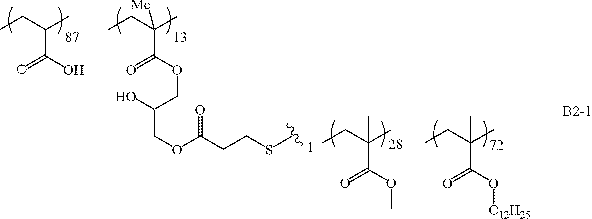

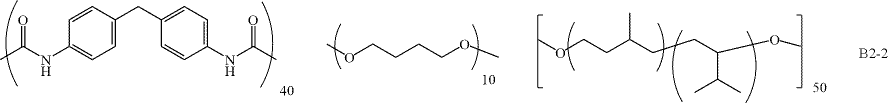

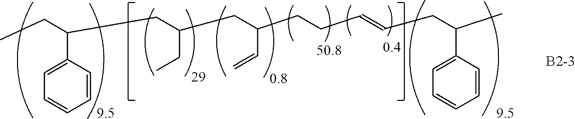

### 1. Synthesis of Polymer and Preparation of Binder Solution or Binder Dispersion Liquid

Polymers shown in the above chemical formulae and Table 1 were synthesized as follows.

### Synthesis Example B-3: Synthesis of Polymer B-3 and Preparation of Binder solution B-3

10.0 g of butyl butyrate, 75.0 g of tetrafluoroethylene, and 25.0 g of 1,3-butadiene were added to an autoclave, 0.1 g of diisopropyl peroxydicarbonate was added thereto, and the resultant mixture was stirred at 30° C. for 24 hours. The obtained polymer solution (entire amount) was transferred to a pressure-resistant reactor equipped with a stirrer, and 4.0 parts by mass of a silica-alumina carrying nickel catalyst (E22U, nickel carrying amount: 60%, manufactured by JGC Catalysts and Chemicals Ltd.) as a hydrogenation catalyst and 100 parts by mass of dehydrated cyclohexane were added thereto and mixed. The inside of the reactor was replaced with hydrogen gas, and hydrogen gas was further supplied while stirring the solution, and a hydrogenation reaction was carried out at a temperature of 170° C. and a pressure of 4.5 MPa for 6 hours. After completion of the hydrogenation reaction, the reaction solution was filtered to remove the hydrogenation catalyst, subsequently filtered through a Zeta Plus (registered trade name) filter 30H (manufactured by 3 M Purification Inc., pore diameter: 0.5 to 1 µm), sequentially filtered with another metal fiber filter (manufactured by NICHIDAI CORPORATION, pore diameter: 0.4 µm) to remove minute solid contents, and then cyclohexane as a solvent and other volatile components were removed from the solution at a temperature of 260° C. and a pressure of 0.001 MPa or less using a cylindrical concentration dryer (KONTRO, manufactured by Hitachi, Ltd.), extruded into a strand shape in a molten state from a die directly connected to the concentration dryer, cooled, and then cut with a pelletizer, thereby obtaining a pellet of a halogenated random polymer B-3. This pellet of the polymer B-3 was dissolved in butyl butyrate to obtain a binder solution B-3 (polymer concentration: 10% by mass) consisting of the polymer B-3.

### Synthesis Example B-6: Synthesis of Polymer B-6 and Preparation of Binder solution B-6

To a 200 mL three-necked flask, 5 g of a polymer T-4 (a commercially available product) described later, 75 g of butyl butyrate, and 0.47 g of diazabicycloundecene (DBU) were added, and stirring was at room temperature for 4 hours. The obtained reaction solution was subjected to liquid separation treatment with 80 g of water to obtain an organic phase, 800 g of hexane was subsequently added thereto carry to reprecipitation, thereby obtaining a halogenated random polymer B-6. The synthesized B-6 was dissolved in butyl butyrate to prepare a binder solution B-6 (polymer concentration: 10% by mass) consisting of the polymer B-6.

### Synthesis Example B-1: Synthesis of Polymer B-1 and Preparation of Binder Solution B-1

10.0 g of butyl butyrate and 10.0 g of vinylidene chloride were added to an autoclave, 0.1 g of diisopropyl peroxydicarbonate was further added thereto, and the resultant mixture was stirred at 30° C. for 24 hours. After the completion of the polymerization reaction, the precipitate was filtered and dried at 100° C. for 10 hours to obtain polyvinylidene chloride.

To a 200 mL three-necked flask, 5 g of polyvinylidene chloride, 75 g of butyl butyrate, and 0.47 g of diazabicycloundecene (DBU) were added, and stirring was at room temperature for 4 hours. The obtained reaction solution was subjected to liquid separation treatment with 80 g of water to obtain an organic phase, 800 g of hexane was subsequently added thereto carry to reprecipitation, thereby obtaining a halogenated random polymer B-1. The synthesized B-1 was dissolved in butyl butyrate to prepare a binder solution B-1 (polymer concentration: 10% by mass) consisting of the polymer B-1.

### Synthesis Examples B-2, B-4, B-5, B-10, B-11, and T-5: Synthesis of Polymers B-2, B-4, B-5, B-10, B-11, and T-5, and Preparation of Binder Solutions B-2, B-4, B-5, B-10, B-11, and T-5

Halogenated random polymers B-2, B-4, B-5, B-10, B-11, and T-5 were synthesized in the same manner as in Synthesis Example B-1 to obtain binder solutions B-2, B-4, B-5, B-10, B-11, and T-5 (polymer concentration: 10% by mass), consisting of respective polymers, except that in Synthesis Example B-1, compounds from which the respective constitutional components were derived was used instead of polyvinylidene chloride so that the compositions of the polymers B-2, B-4, B-5, B-10, B-11, and T-5 respectively had the compositions (the kinds and the contents of the constitutional components) represented by the above-described chemical formulae.

### Synthesis Example B-8: Synthesis of Polymer B-8 and Preparation of Binder solution B-8

To a 100 mL three-necked flask, 5 g of the polymer B-4 synthesized in Synthesis Example B-4, 50 g of dimethylacetamide, 14 g of 1-dodecanethiol, and 0.94 g of a polymerization initiator V-601 (product name, manufactured by FUJIFILM Wako Pure Chemical Corporation) was added, and stirring was carried out at 80° C. for 6 hours. 600 g of water was added to the obtained reaction solution and reprecipitation was carried out to obtain solid contents, which were subsequently washed with hexane to obtain a halogenated random polymer B-8. The synthesized B-8 was dissolved in butyl butyrate to prepare a binder solution B-8 (polymer concentration: 10% by mass) consisting of the polymer B-8.

### Synthesis Examples B-7, B-9, and T-8: Synthesis of Polymers B-7, B-9, and T-8, and Preparation of Binder Solutions B-7, B-9, and T-8

Halogenated random polymers B-7, B-9, and T-8 were synthesized in the same manner as in Synthesis Example B-8, except that in Synthesis Example B-8, a compound from which each constitutional component is derived was adjusted so that the polymers B-7, B-9, and T-8 had the composition (the kind and the content of the constitutional component) shown in the above chemical formula. The polymers B-7, B-9, and T-8, synthesized in this way, were dissolved in butyl butyrate to respectively prepare binder solutions B-7, B-9, and T-8 consisting of the polymers B-7, B-9, and T-8 (polymer concentration: 10% by mass).

### Synthesis of Mercaptopropionic Acid B-7 to Which a Polymerized Chain is Bonded

A macromonomer (a compound from which the constitutional component XC is derived) b-7 to be used in the synthesis of the polymer B-7 was synthesized as follows. That is, to a 1,000 mL three-necked flask, 71.3 g of butyl butyrate was added and stirred at 80° C., and then the above monomer solution b-7 prepared below was added dropwise thereto over 2 hours, followed by further stirring at 80° C. for 2 hours. After further adding thereto 0.42 g of the polymerization initiator V-601, the temperature was raised to 95° C., and stirring was further carried out for 2 hours. The obtained reaction solution was reprecipitated with methanol to synthesize a mercaptopropionic acid b-7 (number average molecular weight: 5,000) to which a polymerized chain was bonded.

### Preparation of Monomer Solution B-7

To a 500 mL graduated cylinder, 161.7 g of dodecyl acrylate, 48.3 g of 1H,1H,2H,2H-tridecafluorooctyl acrylate, 3.85 g of 3-mercaptopropionic acid, and 4.20 g of a polymerization initiator V-601 (product name) were added and dissolved in 57.0 g of butyl butyrate to prepare a monomer solution b-7.

### Synthesis Example T-1: Synthesis of Polymer T-1 and Preparation of Binder Solution T-1

To a 100 mL graduated cylinder, 23.4 g of dodecyl acrylate, and 0.36 g of a polymerization initiator V-601 (product name) were added and dissolved in 36.0 g of butyl butyrate to prepare a monomer solution.

To a 300 mL three-necked flask, 18 g of butyl butyrate was added and stirred at 80° C., and then the above monomer solution was added dropwise thereto over 2 hours. After completion of the dropwise addition, the temperature was raised to 90° C., and stirring was carried out for 2 hours to synthesize a (meth)acrylic polymer T-1, whereby a binder solution T-1 (concentration of polymer T-1: 40% by mass) consisting of the polymer T-1 was obtained.

### Synthesis Example T-7: Synthesis of Polymer T-7 and Preparation of Binder Solution T-7

In a 200 mL graduated cylinder, hydrobromic acid was added to a solution of 36.0 g of butyl butyrate, containing 20.0 g of a SEBS block copolymer (Tuftec (registered trade name) H1052, manufactured by Asahi Kasei Corporation), and stirring was carried out at room temperature for 2 hours. After the reaction, reprecipitation was carried out with acetone to obtain a block polymer T-7. The polymer T-7 synthesized in this way was dissolved in butyl butyrate to prepare a binder solution T-7 (polymer concentration: 10% by mass) consisting of the polymer T-7.

### Synthesis Example T-9: Synthesis of Polymer T-9 and Preparation of Binder Dispersion liquid T-9

550 parts by mass of dehydrated cyclohexane, 20.0 parts by mass of dehydrated α-fluorostyrene, and 0.475 g of n-dibutyl ether were placed in a reactor equipped with a stirrer, the inside of which was sufficiently replaced with nitrogen, 0.485 parts by mass of n-butyl lithium (15% cyclohexane solution) was added thereto with stirring at 60° C. to initiate a polymerization reaction, and further subjected to the reaction at 60° C. for 60 minutes with stirring. Next, 60.0 parts by mass of dehydrated isoprene was added thereto, and stirring was continued at the same temperature for 30 minutes. Then, 20.0 parts by mass of dehydrated styrene was further added thereto, and stirring was carried out at the same temperature for 60 minutes. Next, 0.5 parts by mass of isopropyl alcohol was added to the reaction solution to terminate the reaction, thereby obtaining a solution containing a block copolymer. Next, the polymer solution was transferred to a pressure-resistant reactor equipped with a stirrer, and 4.0 parts by mass of a silica-alumina carrying nickel catalyst (E22U, nickel carrying amount: 60%, manufactured by JGC Catalysts and Chemicals Ltd.) as a hydrogenation catalyst and 100 parts by mass of dehydrated cyclohexane were added thereto and mixed. The inside of the reactor was replaced with hydrogen gas, hydrogen gas was further supplied while stirring the solution, and a hydrogenation reaction was carried out at a temperature of 170° C. and a pressure of 4.5 MPa for 6 hours. After completion of the hydrogenation reaction, the reaction solution was filtered to remove the hydrogenation catalyst, subsequently filtered through a Zeta Plus (registered trade name) filter 30H (manufactured by 3 M Purification Inc., pore diameter: 0.5 to 1 µm), sequentially filtered with another metal fiber filter (manufactured by NICHIDAI CORPORATION, pore diameter: 0.4 µm) to remove minute solid contents, and then cyclohexane as a solvent and other volatile components were removed from the solution at a temperature of 260° C. and a pressure of 0.001 MPa or less using a cylindrical concentration dryer (KONTRO, manufactured by Hitachi, Ltd.), extruded into a strand shape in a molten state from a die directly connected to the concentration dryer, cooled, and then cut with a pelletizer, thereby obtaining a pellet of a block polymer T-9, which was a block copolymer hydride. This pellet of the polymer T-9 was dissolved in butyl butyrate to prepare a binder solution T-9 (polymer concentration: 10% by mass) consisting of the polymer T-9.

### Synthesis Example B2-1: Synthesis of Polymer B2-1 and Preparation of Binder Dispersion Liquid B2-1

A (meth)acrylic polymer B2-1 was synthesized in the same manner as in Synthesis Example T-1, except that in Synthesis Example T-1, a compound from which each constitutional component is derived was adjusted so that the polymer B2-1 had the composition (the kind and the content of the constitutional component) shown in the above chemical formula. The polymer B2-1 synthesized in this way was stirred in butyl butyrate to prepare a dispersion liquid (polymer concentration: 10% by mass, average particle diameter of polymer B2-1: 50 nm) of a binder consisting of the polymer B2-1.

### Synthesis of Macromonomer B2-1

A macromonomer b2-1 used in the synthesis of the polymer B2-1 was synthesized as follows.

That is, to a 1,000 mL three-necked flask, 71.3 g of butyl butyrate was added and stirred at 80° C., and then the above monomer solution 2-1 prepared below was added dropwise thereto over 2 hours, followed by further stirring at 80° C. for 2 hours. After further adding thereto 0.42 g of the polymerization initiator V-601, the temperature was raised to 95° C., and stirring was further carried out for 2 hours. To the mixture obtained in this way, 6.2 g of glycidyl methacrylate, 0.2 g of 4-hydroxy-2,2,6,6-tetramethylpiperidin-1-oxyl free radical, and 2.6 g of tetrabutylammonium bromide were further added, and the resultant mixture was stirred at 100° C. for 3 hours. The obtained reaction solution was reprecipitated with methanol to synthesize a macromonomer b2-1 (number average molecular weight: 5,000).

### Preparation of Monomer Solution B2-1

To a 500 mL graduated cylinder, 58.8 g of methyl methacrylate, 151.2 g of dodecyl acrylate, 3.85 g of 3-mercaptopropionic acid, and 4.20 g of a polymerization initiator V-601 (product name) were added and dissolved in 57.0 g of butyl butyrate to prepare a monomer solution b2-1.

### Synthesis Example B2-2: Synthesis of Polymer B2-2 and Preparation of Binder Dispersion Liquid B2-2

To a 500 mL three-necked flask, 0.92 g of 1,4-butanediol and 4.6 g of EPOL (product name, terminal diol-modified hydrogenated polyisoprene, mass average molecular weight: 2,500, manufactured by Idemitsu Kosan Co., Ltd.) were added and dissolved in 50 mL of tetrahydrofuran (THF). To this solution, 3.7 g of 4,4′-diphenylmethane diisocyanate was added and stirred at 60° C. to be uniformly dissolved. To this solution, 50 mg of Neostan U-600 (product name, a bismuth-base catalyst, manufactured by Nitto Kasei Co., Ltd.) was added and then heated and stirred at 60° C. for 4 hours to obtain a cloudy viscous polymer solution. 1 g of methanol was added to this solution to seal the terminal of the polymer, thereby terminating the polymerization reaction.

Next, 96 g of octane was added dropwise over 1 hour to the polymer solution obtained above, which was under vigorous stirring at 500 rpm, to obtain an emulsified liquid. The emulsified liquid obtained while allowing nitrogen gas to flow was heated at 85° C. to remove THF remaining in the emulsified liquid. The operation of adding 50 g of octane to the residue and removing the solvent in the same manner was repeated 4 times. In this way, the residual amount of THF was reduced to 1% by mass or less, whereby a 10% by mass octane dispersion liquid of the urethane polymer B2-2 was obtained. The average particle diameter of the polymer B2-2 in this dispersion liquid was 5 nm.

### Preparation Examples T-2 to T-4 and T-6: Preparation of Binder Solutions T-2 to T-4 and T-6

The following polymers T-2 to T-4 and T-6 were each dissolved in butyl butyrate to prepare respective binder solutions T-2 to T-4 and T-6 (solid content concentration: 10% by mass).
Polymer T-2: KF polymer (manufactured by Kureha Corporation)
Polymer T-3: Tecnoflon (registered trade name) NH (manufactured by Solvay S.A.)
Polymer T-4: Tecnoflon (registered trade name) TN (manufactured by Solvay S.A.)
Polymer T-6: DYNARON 2324P (manufactured by JSR Corporation)

### Preparation Example B2-3: Preparation of Polymer Dispersion Liquid B2-3

A block polymer B2-3 (Tuftec (registered trade name) H1052 (manufactured by Asahi Kasei Corporation)) was dispersed in butyl butyrate to prepare a binder dispersion liquid B2-3 (solid content concentration: 10% by mass, average particle diameter of polymer B2-3: 50 nm) consisting of the polymer B2-3.

Table 1 shows the results of measuring the content of the carbon-carbon double bond and the mass average molecular weight according to the above-described measuring methods regarding each of the polymers synthesized or obtained. The kind of halogen atom that is directly connected to the main chain of each polymer is shown in the column of “Halogen atom”. Table 2 shows the results of measuring the content of the organic base in each binder.

It is noted that the unit of the content of the carbon-carbon double bond is “the number of mmol per 1 g of polymer”, which will be omitted in Table 1. In addition, although the unit of the content of the organic base is “% by mass”, it is omitted in Table 2.

Each constitutional component in each polymer can be identified, for example, by ¹H-NMR, ¹⁹F-NMR, ¹³C-NMR, two-dimensional NMR, or by a combination thereof.

### Measurement of Content of Carbon-Carbon Double Bond (Iodine Value Method)

The content (mmol/g) of the carbon-carbon double bond was calculated based on the iodine value obtained as described below.

1.0 g of a polymer was weighed, placed in an Erlenmeyer flask, 50 mL of chloroform (THF in the case of insoluble matter) was added thereto, the Erlenmeyer flask was stoppered, and the sample (the polymer) was completely dissolved at room temperature using a shaker. After the sample was completely dissolved, the sample was allowed to stand in a constant temperature water bath at 25° C. ± 1° C. for about 30 minutes. Then, the Erlenmeyer flask was taken out from the constant temperature water bath, 25 mL of the Wyeth solution was added thereto with a pipette, the Erlenmeyer flask was stoppered, and the mixture was gently shaken until it became uniform. Next, the mixture was allowed to stand in a constant temperature water bath at 25° C. ± 1° C. for 120 minutes ± 5 minutes to terminate the addition reaction of the iodine value. Next, the Erlenmeyer flask was taken out from the constant temperature water bath, 10 mL of a 10% potassium iodide aqueous solution was quickly added using a pipette, and the Erlenmeyer flask was immediately stoppered and vigorously shaken. The stopper was loosened slightly, and then, using a washing bottle, the stopper and the joint were washed with as little distilled water as possible, which was poured directly into the Erlenmeyer flask. The Erlenmeyer flask was stoppered again, gently shaken, and then allowed to stand at room temperature for 5 minutes. Next, using a 0.1 M aqueous sodium thiosulfate solution, the Erlenmeyer flask was titrated while gently shaking. When the aqueous phase of the upper layer turned slightly yellow, about 1 cm³ of a 1% aqueous starch solution was added thereto, the Erlenmeyer flask was stoppered and then vigorously shaken. The titration was continued while shaking the Erlenmeyer flask well until the purple color disappeared due to the reaction between iodine and starch. It is important that the titration with the aqueous sodium thiosulfate solution is completed within 30 minutes after the addition of the potassium iodide aqueous solution. In addition, in a case where an aqueous starch solution is added, it is important to carry out vigorous shaking so that unreacted iodine contained in the chloroform phase is completely reacted with the starch in the aqueous phase. After the Erlenmeyer flask stoppered, it was allowed to stand at room temperature for about 30 minutes. After the color was developed again, the titration solution was added, and the mixture was shaken well until the color completely disappeared. A blank test was also carried out without a sample. The iodine value is calculated up to the second decimal place according to the following expression.

$$\text{A=((V0-V1)c} \times \text{12} \text{.69)/m}$$

The symbols in the expression are as follows.
A: Iodine value (iodine g/sample 100 g)
V0: Titration amount in blank test (cm³)
V1: Titration amount of sample (cm³)
m: Mass of sample (g)
c: Concentration of sodium thiosulfate solution (mol/L)
12.69: Atomic weight of iodine, 126.9 × 100/1000

TABLE 1

| Polymer No. | Halogen atom | Content of double bond | Mass average molecular weight |
|---|---|---|---|
| B-1 | Cl | 2.00 | 300,000 |
| B-2 | Br | 2.00 | 320,000 |
| B-3 | F | 0.08 | 150,000 |
| B-4 | F | 2.00 | 290,000 |
| B-5 | F | 2.00 | 119,000 |
| B-6 | F | 2.00 | 420,000 |
| B-7 | F | 0.10 | 350,000 |
| B-8 | F | 0.10 | 360,000 |
| B-9 | F | 0.10 | 370,000 |
| B-10 | F | 9.00 | 290,000 |
| B-11 | Br | 2.00 | 290,000 |
| T-1 | - | 0.00 | 95,000 |
| T-2 | F | 0.00 | 300,000 |
| T-3 | F | 0.00 | 1,190,000 |
| T-4 | F | 0.00 | 439,000 |
| T-5 | F | 16.00 | 300,000 |
| T-6 | - | 0.11 | 200,000 |
| T-7 | Br | 0.13 | 91,000 |
| T-8 | F | 0.00 | 310,000 |
| T-9 | F | 0.07 | 83,000 |

### 2. Synthesis of Sulfide-Bsed Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: -70° C.), lithium sulfide (Li₂S, manufactured by Sigma-Aldrich Co., LLC Co., LLC Co., LLC, purity: > 99.98%) (2.42 g) and diphosphorus pentasulfide (P₂S₅, manufactured by Sigma-Aldrich Co., LLC Co., LLC Co., LLC, purity: > 99%) (3.90 g) each were weighed, put into an agate mortar, and mixed using an agate pestle for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining yellow powder (6.20 g) of a sulfide-based inorganic solid electrolyte (Li-P-S-based glass, hereinafter, may be referred to as LPS). The particle diameter of the Li-P-S-based glass was 15 µm.

### Example 1

Each composition shown in Table 2 was prepared as follows. It is noted that the solid content concentration (the composition content of the dispersion medium) of each composition was set to be a concentration that enables coating based on the result of <Evaluation 1: Dispersibility (solid content concentration)> described later.

### Preparation of Inorganic Solid Electrolyte-Containing Compositions K-1, K-2, and KC-1 to KC-9

Zirconia beads (0.90 g per 1 g of slurry) having a diameter of 5 mm was put into a 45 mL container made of zirconia (manufactured by FRITSCH), and the LPS synthesized in Synthesis Example A, the binder solution or the dispersion liquid, and butyl butyrate as a dispersion medium were put thereinto at a mass proportion satisfying the composition shown in Table 2-1 and Table 2-3. Then, this container was set in a planetary ball mill P-7 (product name) manufactured by FRITSCH. Mixing was carried out at a temperature of 25° C. and a rotation speed of 150 rpm for 10 minutes to prepare each of inorganic solid electrolyte-containing compositions (slurries) K-1, K-2, and KC-1 to KC-9.

### Preparation of Positive Electrode Compositions PK-1 to PK-17

Zirconia beads having a diameter of 5 mm were put into a 45 mL container made of zirconia (manufactured by FRITSCH), and then the LPS synthesized in Synthesis Example A, and butyl butyrate as a dispersion medium were put thereinto. The container was set in a planetary ball mill P-7 (product name, manufactured by FRITSCH) and the components were stirred for 30 minutes at 25° C. and a rotation speed of 200 rpm. Then, NMC (manufactured by Sigma-Aldrich Co., LLC) as the positive electrode active material, acetylene black (AB) as a conductive auxiliary agent, and the binder solution or the dispersion liquid were put into this container, and the container was set in the planetary ball mill P-7, mixing was continued for 30 minutes at a temperature of 25° C. and a rotation speed of 200 rpm to prepare each of positive electrode compositions (slurries) PK-1 to PK-17.

Each compound was mixed at a mass ratio satisfying the content shown in Table 2-1.

It is noted that in the positive electrode compositions PK-12 to PK-14, the binder solutions B-7 to B-9 and the binder dispersion liquids B2-1 to B2-3 were used in equal amounts in terms of solid content.

### Preparation of Negative Electrode Compositions NK-1 to NK-17 and NKC-1 to NKC-9

Zirconia beads having a diameter of 5 mm were put into a 45 mL container made of zirconia (manufactured by FRITSCH), and then the LPS synthesized in Synthesis Example A, the binder solution or the dispersion liquid, and dispersion medium were put thereinto. The container was set in a planetary ball mill P-7 (product name, manufactured by FRITSCH) and the components were mixed for 60 minutes at a temperature of 25° C. and a rotation speed of 300 rpm. Then, silicon (Si, manufactured by Sigma-Aldrich Co., LLC) as the negative electrode active material and VGCF (manufactured by Showa Denko K.K.) as the conductive auxiliary agent were put into the container. Similarly, the container was subsequently set in a planetary ball mill P-7, and mixing was carried out at 25° C. for 10 minutes at a rotation speed of 100 rpm to prepare each of negative electrode compositions (slurries) NK-1 to NK-17 and NKC-1 to NKC-9.

Each compound was mixed at a mass ratio satisfying the content shown in Table 2-2 and Table 2-3.

It is noted that in the negative electrode compositions NK-12 to NK-14, the binder solutions B-7 to B-9 and the binder dispersion liquids B2-1 to B2-3 were used in equal amounts in terms of solid content.

Regarding the halogenated random polymers B-9 used in the positive electrode compositions PK-15 to PK-17 and the negative electrode compositions NK-15 to NK-17, it is noted that the content of the organic base contained in the polymer B-9 was adjusted by changing the using amount of diazabicycloundecene that was used in each synthesis (dehydrohalogenation reaction).

In Table 2-1 to Table 2-3 (collectively referred to as Table 2), the solid content concentration and the composition content of the dispersion medium are values calculated from the amounts of the compounds used in the preparation of each composition, and the composition content of the compound other than the dispersion medium is a value calculated (converted) based on the above-described solid content concentration shown in Table 2. The composition content is the content (% by mass) with respect to the total mass of the composition, and the solid content is the content (% by mass) with respect to 100% by mass of the solid content of the composition. The unit is omitted in the table. It is noted that since two kinds of polymer binders are used in combination in the positive electrode compositions PK-12 to PK-14 and the negative electrode compositions NK-12 to NK-14, the two kinds of polymer binders are described together using″/” in the column of “Binder solution or dispersion liquid” of the above compositions, and for the composition content and the solid content, the total amounts of the two polymer binders are described.

In addition, Table 2 shows the results of measuring the content of the organic base (DBU) contained in each binder in the polymer binder solution (although the unit is % by mass, it is omitted in Table 2) according to the following method. It is noted that the measurement results of the following method (1) and the measurement results of the following method (2) were substantially the same. In Table 2, in the positive electrode compositions PK-12 to PK-14 and the negative electrode compositions NK-12 to NK-14, the content of the organic base of each binder is described together using″/” in the column of “Organic base content”.

### Measurement of Content of Organic Base in Binder

A binder consisting of a polymer was subjected to ¹H-NMR measurement to determine the content from a ratio of an integrated value of a peak derived from an organic base (DBU) and an integrated value of a peak derived from a polymer that constitutes a binder in the obtained chart.

A binder consisting of a polymer was dissolved in an organic solvent (THF or the like) and titrated with an acid (acetic acid or the like) to determine the content of the organic base.

TABLE 2–1

| | No. | | Inorganic solid electrolyte | | Binder solution or Dispersion liquid | | | | Dispersion medium | | Active material | | | Conductive auxiliary agent | | | None |
|---|---|---|---|---|---|---|---|---|---|---|---|---|---|---|---|---|---|
| | | | Composition content | Solid content composition | | Inorganic base content | Composition content | Solid content composition | | Composition content | | Composition content | Solid content composition | | Composition content | Solid content composition | |
| Inorganic solid electrolyte-containing composition | K-1 | LPS | 50 | 92 | B-1 | 0.02 | 4 | 5 | Buryl butyrate | 46 | - | - | - | - | - | - | Present inventions |
| | K-2 | LPS | 70 | 92 | B-9 | 0.01 | 6 | 5 | Buryl butyrate | 24 | - | - | - | - | - | - | Present inventions |
| Positive electrode composition | PK-1 | LPS | 12 | 21 | B-1 | 0.02 | 1 | 2 | Buryl butyrate | 43 | NMC | 42 | 74 | AB | 2 | 3 | Present invention |
| | PK-2 | LPS | 12 | 21 | B-2 | 0.02 | 1 | 2 | Buryl butyrate | 43 | NMC | 42 | 74 | AB | 2 | 3 | Present invention |
| | PK-3 | LPS | 12 | 21 | B-3 | 0.00 | 1 | 2 | Butyl butyrate | 43 | NMC | 42 | 74 | AB | 2 | 3 | Present invention |
| | PK-4 | LPS | 14 | 21 | B-4 | 0.02 | 1 | 2 | Butyl butyrate | 34 | NMC | 49 | 74 | AB | 2 | 3 | Present invention |
| | PK-5 | LPS | 14 | 21 | B-5 | 0.02 | 1 | 2 | Butyl butyrate | 34 | NMC | 49 | 74 | AB | 2 | 3 | Present invention |
| | PK-6 | LPS | 14 | 21 | B-6 | 0.02 | 1 | 2 | Buryl butyrate | 34 | NMC | 49 | 74 | AB | 2 | 3 | Present invention |
| | PK-7 | LPS | 16 | 21 | B-7 | 0.01 | 2 | 2 | Buryl butyrate | 24 | NMC | 56 | 74 | AB | 2 | 3 | Present inventions |
| | PK-8 | LPS | 16 | 21 | B-8 | 0.01 | 2 | 2 | Buryl butyrate | 24 | NMC | 56 | 74 | AB | 2 | 3 | Present inventions |
| | PK-9 | LPS | 16 | 21 | B-9 | 0.01 | 2 | 2 | Buryl butyrate | 24 | NMC | 56 | 74 | AB | 2 | 3 | Present inventions |
| | PK-10 | LPS | 14 | 21 | B-10 | 0.02 | 1 | 2 | Buryl butyrate | 34 | NMC | 49 | 74 | AB | 2 | 3 | Present inventions |
| | PK-11 | LPS | 12 | 21 | B-11 | 0.02 | 1 | 2 | Buryl butyrate | 43 | NMC | 42 | 74 | AB | 2 | 3 | Present inventions |
| | PK-12 | LPS | 16 | 21 | B-?/B2-1 | 0.01/0.00 | 2 | 2 | Buryl butyrate | 24 | NMC | 56 | 74 | AB | 2 | 3 | Present inventions |
| | PK-13 | LPS | 16 | 21 | B-8/B2-? | 0.01-0.00 | 2 | 2 | Buryl butyrate | 24 | NMC | 56 | 74 | AB | 2 | 3 | Present inventions |
| | PK-14 | LPS | 16 | 21 | B9/B2-? | 0.00-0.00 | 2 | 2 | Buryl butyrate | 24 | NMC | 56 | 74 | AB | 2 | 3 | Present inventions |
| | PK-15 | LPS | 16 | 21 | B-9 | 0.00 | 2 | 2 | Buryl butyrate | 24 | NMC | 56 | 74 | AB | 2 | 3 | Present inventions |
| | PK-16 | LPS | 16 | 21 | B-9 | 0.90 | 2 | 2 | Buryl butyrate | 24 | NMC | 56 | 74 | AB | 2 | 3 | Present inventions |
| | PK-17 | LPS | 16 | 21 | B-9 | 1.50 | 2 | 2 | Buryl butyrate | 24 | NMC | 56 | 74 | AB | 2 | 3 | Present inventions |
| Negative electrode composition | NK-1 | LPS | 28 | 50 | B-1 | 0.02 | 1 | 2 | Butyl buryate | 44 | Si | 25 | composition 44 | VGCF | 2 | 4 | Present invention |
| | NK-2 | LPS | 28 | 50 | B-2 | 0.02 | 1 | 2 | Buryl butyrate | 44 | 81 | 25 | 44 | VGCF | 2 | 4 | Present Invention |
| | NK-3 | LPS | 28 | 50 | B-3 | 0.00 | 1 | 2 | Butyl butyrate | 44 | 51 | 25 | 44 | VGCF | 2 | 4 | Present invention |
| | NK-4 | LPS | 32 | 50 | 5-4 | 0.02 | 1 | 2 | Bury butyrate | 34 | 81 | 28 | 44 | VGCF | 3 | 4 | Present inveurion |
| | NK-5 | LPS | 32 | 50 | B-5 | 0.02 | 1 | 2 | Bury butyrate | 36 | Si | 28 | 44 | VGCF | 3 | 4 | Present invention |
| | NK-6 | LP5 | 32 | 50 | B-6 | 0.02 | 1 | 2 | Butyl buryrate | 36 | Si | 28 | 44 | VGCF | 3 | 4 | Present invention |
| | NK-7 | LPS | 38 | 50 | B-7 | 0.01 | 2 | 2 | Buryl butyrate | 24 | Si | 33 | 44 | VGCF | 3 | 4 | Present invention |
| | NK-8 | LPS | 38 | 50 | B-S | 0.01 | 2 | 2 | Buryl buryrate | 24 | Si | 33 | 44 | VGCF | 3 | 4 | Present invention |
| | NK-9 | LPS | 38 | 50 | B-9 | 0.01 | 2 | 2 | Butyl butyrate | 24 | Si | 33 | 44 | VGCF | 3 | 4 | Preset invention |
| | NK-10 | LPS | 32 | 50 | B-10 | 0.02 | 1 | 2 | Butyl buryrate | 36 | Si | 28 | 44 | VGCF | 3 | 4 | Present invention |
| | NK-11 | LPS | 28 | 50 | B-11 | 0.02 | 1 | 2 | Butyl butyrate | 44 | Si | 25 | 44 | VGCF | 2 | 4 | Present invention |
| | NK-12 | LPS | 38 | 50 | B-7/B2-1 | 0.01/0.00 | 2 | 2 | Butyl butyrate | 24 | Si | 33 | 44 | VGCF | 3 | 4 | Present invention |
| | NK-13 | LPS | 38 | 50 | B-8/B2-2 | 0.01/0.00 | 2 | 2 | Buryl butyrate | 24 | Si | 33 | 44 | VGCF | 3 | 4 | Present invention |
| | NK-14 | LPS | 38 | 50 | B-9/B2-3 | 0.01/0.00 | 2 | 2 | Butyl butyrate | 24 | Si | 33 | 44 | VGCF | 3 | 4 | Present invention |
| | NK-15 | LPS | 38 | 50 | B-9 | 0.00 | 2 | 2 | Butyl butyrate | 24 | Si | 3.3 | 44 | VGCF | 3 | 4 | Present invention |
| | NK-16 | LPS | 38 | 50 | B-9 | 0.90 | 2 | 2 | Butyl butyrate | 24 | Si | 33 | 44 | VGCF | 3 | 4 | Present invention |
| | NK-17 | LPS | 38 | 50 | B-9 | 1.50 | 2 | 2 | Butyl butyrate | 24 | Si | 33 | 44 | VGCF | 3 | 4 | Present invention |
| Inorganic solid electrolyte-containing composito n | KC-1 | LPS | 16 | 94 | T-1 | 0.00 | 1 | 8 | Butyl butyrate | 83 | - | - | - | - | - | - | Comparative Example |
| | KC-2 | LPS | 16 | 94 | T-2 | 0.00 | 1 | 6 | Butyl butyrate | 83 | - | - | - | - | - | - | Example |
| | KC-3 | LP 8 | 16 | 94 | T-3 | 0.00 | 1 | 6 | Butyl butyrate | 83 | - | - | - | - | - | - | Comparative Example |
| | KC-4 | LP | 16 | 94 | T-4 | 0.00 | 1 | 6 | Buryl butyrate | 83 | - | - | - | - | - | - | Comparative Example |
| | KC-5 | LPS | 16 | 94 | T-S | 0.02 | 1 | 6 | Buryl butyrate | 83 | - | - | - | - | - | - | Comparative Example |
| | KC-6 | LPS | 50 | 94 | T-6 | 0.00 | 3 | 6 | Buryl butyrate | 47 | - | - | - | - | - | - | Comparative Example |
| | KC-7 | LPS | 16 | 94 | T-7 | 0.00 | 1 | 6 | Butyl butyrate | 83 | - | - | - | - | - | - | Comparative Example |
| | KC-8 | LPS | 16 | 94 | T-8 | 0.00 | 1 | 6 | Buryl butyrate | 83 | - | - | - | - | - | - | Comparative Example |
| | KC-9 | LPS | 16 | 94 | T-P | 0.00 | 1 | 6 | Butyl butyrate | 83 | - | - | - | - | - | - | Comparative Example |
| Negative electrode composition | NKC–1 | LPS | 16 | 43 | | 0.00 | 1 | 2 | Butyl butyrate | 62 | Si | 19 | 50 | VGCF | 2 | 5 | Comparative Example |
| | NKC-2 | LPS | 16 | 43 | T-2 | 0.00 | 1 | 2 | Buryl butyrate | 62 | Si | 19 | 50 | VGCF | 2 | 5 | Comparative Example |
| | NKC-3 | LPS | 16 | 43 | T-3 | 0.00 | 1 | 2 | Butyl butyrate | 62 | Si | 19 | 50 | VGCF | 2 | 5 | Comparative Example |
| | NKC-4 | LPS | 16 | 43 | T-4 | 0.00 | 1 | 2 | Butyl butyrate | 62 | Si | 19 | 50 | VGCF | 2 | 5 | Comparative Example |
| | NKC-5 | LPS | 16 | 43 | T-5 | 0.02 | 1 | 2 | Butyl butyrate | 62 | Si | 19 | 50 | VGCF | | 5 | Comparative Example |
| | NKC-6 | LPS | 25 | 43 | T-6 | 0.00 | 1 | 2 | Butyl butyrate | 42 | Si | 29 | 50 | VGCF | 3 | 5 | Comparative Example |
| | NKC-7 | LPS | 16 | 43 | T-7 | 0.00 | 1 | 2 | Buryl butyrate | 62 | Si | 19 | 50 | VGCF | 2 | 5 | Comparative Example |
| | NKC-8 | LPS | 16 | 43 | T-8 | 0.00 | 1 | 2 | Buryl butyrate | 62 | Si | 19 | 50 | VGCF | 2 | 5 | Comparative Example |
| | NKC-9 | LPS | 16 | 43 | T-9 | 0.00 | 1 | 2 | Butyl butyrate | 62 | 51 | 19 | 50 | VGCF | 2 | 5 | Comparative Example |

### Abbreviations in Table

LPS: LPS synthesized in Synthesis Example A
NMC: LiNi_{⅓}Co_{⅓}Mn_{⅓}O₂
Si: Silicon
AB: Acetylene black
VGCF: Carbon nanotube (manufactured by Showa Denko K.K.)

### Production of Solid Electrolyte Sheets 101, 102, and C11 to C19 for All-Solid State Secondary Battery

Each of the inorganic solid electrolyte-containing compositions shown in the column of “Solid electrolyte composition No.” of Table 3-1 and Table 3-3 obtained as described above was applied onto an aluminum foil having a thickness of 20 µm using a baker type applicator (product name: SA-201, manufactured by Tester Sangyo Co., Ltd.) and heated at 80° C. for 2 hours to dry (to remove the dispersion medium) the inorganic solid electrolyte-containing composition. Then, using a heat press machine, the inorganic solid electrolyte-containing composition dried at a temperature of 120° C. and a pressure of 40 MPa for 10 seconds was heated and pressurized to produce each of solid electrolyte sheets 101 to 102 and c11 to c19 for an all-solid state secondary battery (in Table 3, it is written as “Solid electrolyte sheet”). The film thickness of the solid electrolyte layer was 50 µm.

### Production of Positive Electrode Sheets 103 to 119 for All-Solid State Secondary Battery

Each of the positive electrode compositions obtained as described above, which is shown in the column of “Electrode composition No.” in Table 3-1, was applied onto an aluminum foil having a thickness of 20 µm by using a baker type applicator (product name: SA-201), heating was carried out at 80° C. for 1 hour, and then heating was further carried out at 110° C. for 1 hour to dry (to remove the dispersion medium) the positive electrode composition. Then, using a heat press machine, the dried positive electrode composition was pressurized (10 MPa, 1 minute) at 25° C. to produce each of positive electrode sheets 103 to 119 for an all-solid state secondary battery, having a positive electrode active material layer having a film thickness of 80 µm (in Table 3, it is written as “Positive electrode sheet”).

### Production of Negative Electrode Sheets 120 to 136 and C21 to C29 for All-Solid State Secondary Battery

Each of the compositions for a negative electrode obtained as described above, which is shown in the column of “Electrode composition No.” of Table 3-2 and Table 3-3, was applied onto a copper foil having a thickness of 20 µm by using a baker type applicator (product name: SA-201), heating was carried out at 80° C. for 1 hour, and then heating was further carried out at 110° C. for 1 hour to dry (to remove the dispersion medium) the negative electrode composition. Then, using a heat press machine, the dried negative electrode composition was pressurized (10 MPa, 1 minute) at 25° C. to produce each of negative electrode sheets 120 to 136 and c21 to c29 for an all-solid state secondary battery, having a negative electrode active material layer having a film thickness of 70 µm (in Table 3, it is written as “Negative electrode sheet”).

The following evaluations were carried out for each of the manufactured compositions and each of the sheets, and the results are shown in Table 3-1 to Table 3-3 (collectively referred to as Table 3).

### Evaluation 1: Dispersibility (Solid Content Concentration)

The LPS, the polymer binder, the dispersion medium, the active material, and the conductive auxiliary agent were mixed in the same conditions as the preparation conditions of each composition at the same proportion as the proportion of the composition content and the solid content shown in Table 2, thereby preparing a composition (a slurry) for dispersibility evaluation.

The obtained composition was visually checked to evaluate whether aggregates of solid particles are generated, and whether the composition can be uniformly (without being out of liquid and at a constant coating thickness) applied at 25° C. using a baker type applicator (product name: SA-201).

This evaluation was repeatedly carried out until aggregates were generated or uniform application became impossible while the solid content concentration in the composition was gradually increased, and the dispersibility was evaluated by determining where the maximum solid content concentration, at which aggregates are not generated and uniform application is possible, is included in any of the following evaluation standards.

In this test, it is indicated that the higher the maximum solid content concentration is, the better the excellent dispersibility of the solid particles can be maintained even in a case where the solid content concentration of the composition is increased, and an evaluation standard “D” or higher is the pass level.

### Evaluation Standards

A: 70% by mass or more
B: Less than 70% by mass and 60% by mass or more
C: Less than 60% by mass and 50% by mass or more
D: Less than 50% by mass and 40% by mass or more
E: Less than 40% by mass

### <Evaluation 2: Adhesiveness>

The adhesiveness of solid particles in the solid electrolyte sheet for an all-solid state secondary battery, the electrode sheet (the positive electrode sheet for an all-solid state secondary battery and the negative electrode sheet for an all-solid state secondary battery), and the adhesiveness between the collector and the active material layer in the electrode sheet were evaluated.

Specifically, a test piece having a length of 20 mm and a width of 20 mm was cut out from each of the produced sheets. 11 cuts were made in the test piece using a utility knife so that the cuts reached the base material (the aluminum foil or the copper foil) at 1 mm intervals parallel to one side. In addition, 11 cuts were made so that the cuts reached the base material at 1 mm intervals in the direction perpendicular to the cuts. In this manner, 100 squares were formed on the test piece.

A Cellophane tape (registered trade name) having a length of 15 mm and a width of 18 mm was attached to the surface of the solid electrolyte layer or the electrode active material layer to cover all the 100 squares. The surface of the Cellophane tape (registered trade name) was rubbed with an eraser and pressed against the solid electrolyte layer or the electrode active material layer to be attached thereto. Two minutes after the Cellophane tape (registered trade name) was attached, the end of the Cellophane tape (registered trade name) was held and pulled upward vertically with respect to the solid electrolyte layer or the electrode active material layer, thereby being peeled off. After peeling off the Cellophane tape (registered trade name), the surface of the solid electrolyte layer or the electrode active material layer was visually observed to count squares in which no defects (chipping, breakage, cracking, peeling, and the like) were present, and further, for the electrode sheet, the number of squares in which no peeling from the collector occur was counted, which were taken as X and Y, respectively. The adhesiveness of the solid particles and furthermore, the adhesiveness of the electrode active material layer to the collector were evaluated by determining where the number X of squares in which defects are not present or the number Y of squares in which the peeling does not occur is included in any of the following evaluation standards.

In this test, it is indicated that the larger the number of squares X counted or the number of squares Y counted, the more excellent the adhesiveness of the solid particles and furthermore, more firm the adhesiveness to the collector is, where an evaluation standard “D” or higher is the pass level.

### Evaluation Standards for Solid Electrolyte Layer

A: X ≥ 90
B: 90> X ≥ 80
C: 80 > X ≥ 70
D: 70 ≥ X ≥ 60
E: 60 > X ≥ 50
F: 50 > X

### Evaluation Standards for Electrode Active Material Layer

A: Y ≥ 80 and X ≥ 90
B: 80 > Y ≥ 70 and 90 > X ≥ 80
C: 70 > Y ≥ 60
D: 60 > Y ≥ 50
E: 50 ≥ Y ≥ 40
F: 40 > Y

### Evaluation 3: Suppression of SE Deterioration

Using sheets of each of the produced solid electrolyte sheet and the electrode sheet, which were respectively those before and after being left in the air (25° C., relative humidity 50%) for 1 hour (exposure to the air) the ion conductivity was measured for a set of all-solid state secondary batteries manufactured in the same manner as in [Manufacture of all-solid state secondary battery] described later. The reduction rate (%) of the ion conductivity of the all-solid state secondary battery into which the sheet before being left to stand was incorporated and the all-solid state secondary battery into which the sheet after being left to stand was incorporated was calculated, and the effect of suppressing the deterioration of the solid electrolyte (SE) was evaluated by determining where the obtained reduction rate was included in any of the following evaluation standards. The ion conductivity was measured in the same manner as in <Evaluation 4: Ion conductivity> described later.

In this test, it is indicated that the smaller the reduction rate (%) of the ion conductivity is, the more the deterioration of the inorganic solid electrolyte due to watery moisture can be suppressed, and an evaluation standard “D” or higher is the pass level.

Reduction rate of ion conductivity (%) = [(ion conductivity of all-solid state secondary battery into which sheet before being left to stand is incorporated - ion conductivity of all-solid state secondary battery into which sheet after being left to stand is incorporated)/ion conductivity before being left to stand] x 100

### Evaluation Standards

A: 90% or more
B: 80% or more and less than 90%
C: 70% or more and less than 80%
D: 60% or more and less than 70%
E: Less than 60%

TABLE 3–1

| Sheer. No. | Solid electrolyte composition No, | Polymer No. | Electrode composition No. | Polymer No. | Solid content concentration | Adhesiveness | SE deterioration suppression | Note 1 | Note 2 |
|---|---|---|---|---|---|---|---|---|---|
| 101 | K-1 | B-1 | - | - | C | B | C | Positive electrode sheet | Present invention |
| 102 | K-2 | B-9 | - | - | A | A | A | | Present invention |
| 103 | - | - | PK-1 | B-1 | C | B | C | Negative electrode sheet | Present Invention |
| 104 | - | - | PK-2 | B-2 | C | B | C | | Present invention |
| 105 | - | - | PK-3 | B-3 | C | C | B | | Present invention |
| 106 | - | - | PK-4 | B-4 | B | A | A | | Present invention |
| 107 | - | - | PK-5 | B-5 | B | A | A | | Present invention |
| 108 | - | - | PK-6 | B-6 | B | A | A | | Present invention |
| 109 | - | - | PK-7 | B-7 | A | A | A | | Present invention |
| 110 | - | - | PK-8 | B-8 | A | A | A | | Present invention |
| 111 | - | - | PK-9 | B-9 | A | A | A | | Present invention |
| 112 | - | - | PK-10 | B-10 | B | B | A | | Present invention |
| 113 | - | - | PK-11 | B-11 | C | B | C | | Present invention |
| 114 | - | - | PK-12 | B-7/B2-1 | A | A | A | | Present invention |
| 115 | - | - | PK-13 | B-8/B2-2 | A | A | A | | Present invention |
| 116 | - | - | PK-14 | B-9/B2-3 | A | A | A | | Present invention |
| 117 | - | - | PK-15 | B-9 | A | B | A | | Present invention |
| 118 | - | - | PK-16 | B-9 | A | A | A | | Present invention |
| 119 | - | - | PK-17 | B-9 | A | B | A | | Present invention |

TABLE 3–2

| Sheer No. | Solid electrolyte composition No. | Polymer No. | Electrode composition No. | Polymer No. | Solid content concentration | Adhesiveness | SE deterioration suppression | Note 1 | Note 2 |
|---|---|---|---|---|---|---|---|---|---|
| 120 | - | - | NK-1 | B-1 | C | B | C | Negative electrode sheet | Present invention |
| 121 | - | - | NK-2 | B-2 | C | B | C | | Present invention |
| 122 | - | - | NK-3 | B-3 | C | C | B | | Present invention |
| 123 | - | - | NK-4 | B-4 | B | A | A | | Present invention |
| 124 | - | - | NK-5 | B-5 | B | A | A | | Present invention |
| 125 | - | - | NK-6 | B-6 | B | A | A | | Present invention |
| 126 | - | - | NK-7 | B-7 | A | A | A | | Present invention |
| 127 | - | - | NK-8 | B-8 | A | A | A | | Present invention |
| 128 | - | - | NK-9 | B-9 | A | A | A | | Present invention |
| 129 | - | - | NK-10 | B-10 | B | B | A | | Present invention |
| 130 | - | - | NK-11 | B-11 | c | B | C | | Present invention |
| 131 | - | - | NK-12 | B-7/B2-1 | A | A | A | | Present invention |
| 132 | - | - | NK-13 | B-8/B2-2 | A | A | A | | Present invention |
| 133 | - | - | NK-14 | B-9/B2-3 | A | A | A | | Present invention |
| 134 | - | - | NK-15 | B-9 | A | B | A | | Present invention |
| 135 | - | - | NK-16 | B-9 | A | A | A | | Present invention |
| 136 | - | - | NK-17 | B-9 | A | B | A | | Present invention |

TABLE 3–3

| | | | | | | | | | |
|---|---|---|---|---|---|---|---|---|---|
| Sheet No. | Solid electrolyte composition No. | Polymer No. | Electrode composition No. | Polymer No. | Solid content concentration | Adhesiveness | SE deterioration suppression | Note 1 | Note 2 |
| c11 | KC-1 | T-1 | - | - | E | E | E | Solid electrolyte sheet | Comparative-Example |
| c12 | KC-2 | T-2 | - | - | E | E | B | | Comparative Example |
| c13 | KC-3 | T-3 | - | - | E | E | B | | Comparative Example |
| c14 | KC-4 | T-4 | - | - | E | E | B | | Comparative Example |
| c15 | KC-5 | T-5 | - | - | E | E | B | | Comparative Example |
| c16 | KC-6 | T-6 | - | - | C | C | E | | Comparative Example |
| c17 | KC-7 | T-7 | - | - | E | E | C | | Comparative Example |
| c18 | KC-8 | T-8 | - | - | E | C | C | | Comparative Example |
| c19 | KC-9 | T-9 | - | - | E | E | C | | Comparative Example |
| c21 | - | - | NKC-1 | T-1 | E | E | E | Negative electrode sheer | Comparative Example |
| c22 | - | - | NKC-2 | T-2 | B | E | B | | Comparative Example |
| c23 | - | - | NKC-3 | T-3 | 7 | E | B | | Comparative Example |
| c24 | - | - | NKC-4 | T-4 | E | E | B | | Comparative Example |
| c25 | - | - | NKC-5 | T-5 | E | E | B | | Comparative Example |
| c26 | - | - | NKC-6 | T-6 | C | C | E | | Comparative Example |
| c27 | - | - | NKC-7 | T-7 | E | E | C | | Comparative Example |
| c28 | - | - | NKC-8 | T-8 | E | C | C | | Comparative Example |
| c29 | - | - | NKC-9 | T-9 | E | E | C | | Comparative Example |

### Manufacture of All-Solid State Secondary Battery

Using the solid electrolyte sheet and electrode sheet produced as above, an all-solid state secondary battery having the layer configuration illustrated in FIG. 1 was manufactured as follows.

### Production of Positive Electrode Sheets 103 to 119 for All-Solid State Secondary Battery, which Include Solid Electrolyte Layer

The solid electrolyte sheet c11 for an all-solid state secondary battery, produced as described above, was overlaid on the positive electrode active material layer of each of the positive electrode sheets for an all-solid state secondary battery shown in the column of “Electrode active material layer (sheet No.)” of Table 4-1 so that the solid electrolyte layer came into contact with the positive electrode active material layer, transferred (laminated) by being pressurized at 50 MPa and 25° C. using a press machine, and then further pressurized at 600 MPa and at 25° C., whereby each of positive electrode sheets 103 to 119 for an all-solid state secondary battery having a thickness of 30 µm (thickness of positive electrode active material layer: 60 µm) was produced.

### Production of Negative Electrode Sheets 120 to 136 and C21 to C29 for All-Solid State Secondary Battery, Which Include Solid Electrolyte Layer

The solid electrolyte sheet for an all-solid state secondary battery shown in the column of “Solid electrolyte layer (sheet No.)” of Table 4-2, prepared as described above, was overlaid on the negative electrode active material layer of each of the negative electrode sheets for an all-solid state secondary battery shown in the column of “Electrode active material layer (sheet No.)” of Table 4-2 so that it came into contact with the negative electrode active material layer, transferred (laminated) by being pressurized at 50 MPa and 25° C. using a press machine, and then pressurized at 600 MPa and at 25° C., whereby each of negative electrode sheets 120 to 136 and c21 to c29 for an all-solid state secondary battery having a thickness of 30 µm (thickness of negative electrode active material layer: 50 µm) was produced.

### Manufacturing of All-Solid State Secondary Battery

An all-solid state secondary battery No. 001 having a layer configuration illustrated in FIG. 1 was manufactured as follows.

(Production of negative electrode sheet No. c21 for all-solid state secondary battery, which includes solid electrolyte layer)

First, a negative electrode sheet No. c21 for an all-solid state secondary battery, which would be used in the manufacture of the all-solid state secondary battery No. 001, was produced.

The solid electrolyte sheet No. 101 for an all-solid state secondary battery shown in the column of “Solid electrolyte layer (sheet No.)” of Table 4-1, prepared as described above, was overlaid on the negative electrode active material layer of the negative electrode sheet No. c21 for an all-solid state secondary battery shown in the column of “Electrode active material layer (sheet No.)” of Table 4-1 so that it came into contact with the negative electrode active material layer, transferred (laminated) by being pressurized at 50 MPa and 25° C. using a press machine, and then pressurized at 600 MPa and at 25° C., whereby each of negative electrode sheet No. c21 for an all-solid state secondary battery having a thickness of 30 µm (thickness of negative electrode active material layer: 50 µm) was produced.

### Manufacture of All-Solid State Secondary Battery

The negative electrode sheet No. c21 for an all-solid state secondary battery (the aluminum foil of the solid electrolyte-containing sheet No. 101 had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. A stainless steel foil (a positive electrode collector) was further layered thereon to form a laminate 12 for an all-solid state secondary battery (a laminate consisting of copper foil - negative electrode active material layer - solid electrolyte layer - positive electrode active material layer - aluminum foil - stainless steel foil). Then, the 2032-type coin case 11 was crimped to manufacture an all-solid state secondary battery No. 001 illustrated in FIG. 2.

An all-solid state secondary battery No. 002 was produced in the same manner as in the manufacture of the all-solid state secondary battery No. 001, except that in the manufacture of the all-solid state secondary battery No. 001, a solid electrolyte sheet No. 102 for an all-solid state secondary battery was used instead of the solid electrolyte sheet No. 101 for an all-solid state secondary battery.

An all-solid state secondary battery No. 101 was manufactured as follows.

The positive electrode sheet No. 103 for an all-solid state secondary battery (the aluminum foil of the solid electrolyte-containing sheet had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. A stainless steel foil was further layered thereon to form a laminate 12 for an all-solid state secondary battery (a laminate consisting of aluminum foil - positive electrode active material layer - solid electrolyte layer - lithium foil - stainless steel foil). Then, the 2032-type coin case 11 was crimped to manufacture an all-solid state secondary battery 13 of No. 101 illustrated in FIG. 2.

The all-solid state secondary battery manufactured in this manner has a layer configuration illustrated in FIG. 1 (however, the lithium foil corresponds to a negative electrode active material layer 2 and a negative electrode collector 1).

Each of all-solid state secondary battery Nos. 102 to 117 was manufactured in the same manner as in the manufacture of the all-solid state secondary battery No. 101, except that in the manufacture of the all-solid state secondary battery No. 101, a positive electrode sheet for an all-solid state secondary battery, which includes a solid electrolyte layer shown in the column of “Electrode active material layer (sheet No.)” of Table 4-1, was used instead of the positive electrode No. 103 for a secondary battery, which has a solid electrolyte layer.

Next, an all-solid state secondary battery No. 118 having a layer configuration illustrated in FIG. 1 was produced as follows.

The negative electrode sheet No. 120 for an all-solid state secondary battery (the aluminum foil of the solid electrolyte-containing sheet had been peeled off), which has the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. A stainless steel foil (a positive electrode collector) was further layered thereon to form a laminate 12 for an all-solid state secondary battery (a laminate consisting of copper foil - negative electrode active material layer - solid electrolyte layer - positive electrode active material layer - aluminum foil - stainless steel foil). Then, the 2032-type coin case 11 was crimped to manufacture an all-solid state secondary battery No. 118 illustrated in FIG. 2.

A positive electrode sheet for an all solid-state secondary battery to be used in the manufacture of the all-solid state secondary battery Nos. 001 and 118) was prepared as follows.

### Preparation of Positive Electrode Composition

180 beads of zirconia beads having a diameter of 5 mm were put into a 45 mL container made of zirconia (manufactured by FRITSCH), 2.7 g of the LPS synthesized in the above Synthesis Example A, and 0.3 g of KYNAR FLEX 2500-20 (product name, PVdF-HFP: polyvinylidene fluoride - hexafluoropropylene copolymer, manufactured by Arkema S.A.) in terms of a solid content mass and 22 g of butyl butyrate were put into the above container. The container was set in a planetary ball mill P-7 (product name, manufactured by FRITSCH) and the components were stirred for 60 minutes at 25° C. and a rotation speed of 300 rpm. Then, 7.0 g of LiNi_{⅓}Co_{⅓}Mn_{⅓}O₂ (NMC) was put into container as the positive electrode active material, and similarly, the container was set in a planetary ball mill P-7, mixing was continued at 25° C. and a rotation speed of 100 rpm for 5 minutes to prepare a positive electrode composition.

### Production of Positive Electrode Sheet for All Solid State Secondary Battery

The positive electrode composition obtained as described above was applied onto an aluminum foil (a positive electrode collector) having a thickness of 20 µm with a baker type applicator (product name: SA-201, manufactured by Tester Sangyo Co., Ltd.), heating was carried out at 100° C. for 2 hours to dry (to remove the dispersion medium) the positive electrode composition. Then, using a heat press machine, the dried positive electrode composition was pressurized (10 MPa, 1 minute) at 25° C. to produce each of positive electrode sheets for an all-solid state secondary battery, having a positive electrode active material layer having a film thickness of 80 µm.

Each of all-solid state secondary battery Nos. 119 to 134 and c101 to c109 was manufactured in the same manner as in the manufacture of the all-solid state secondary battery No. 118, except that in the manufacture of the all-solid state secondary battery No. 118, a negative electrode sheet for an all-solid state secondary battery, which includes a solid electrolyte layer shown in the column of “Electrode active material layer (sheet No.)” of Table 4-2, was used instead of the negative electrode No. 120 for a secondary battery, which has a solid electrolyte layer.

The following evaluations were carried out for each of the manufactured all-solid state secondary battery, and the results are shown in Table 4-1 and Table 4-2 (collectively referred to as Table 4).

### Evaluation 4: Ion Conductivity

The ion conductivity of each of the manufactured all-solid state secondary batteries was measured. Specifically, the alternating-current impedance of each of the all-solid state secondary batteries was measured in a constant-temperature tank (25° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (1).

$$\begin{matrix}\text{Ion conductivity} \text{σ} \left(\text{mS} / \text{cm}\right) = 1 , 000 \times \text{sample layer} \\ \text{thickness} \left(\text{cm}\right) / \left[\text{resistance} \left(\text{Ω}\right) \times \text{sample area} \left({\text{cm}}^{2}\right)\right)\end{matrix} \qquad \text{Expression (1):}$$

In Expression (1), the sample layer thickness is a value obtained by measuring the thickness before placing the laminate 12 in the 2032-type coin case 11 and subtracting the thickness of the collector (the total layer thickness of the solid electrolyte layer and the electrode active material layer). The sample area is the area of the disk-shaped sheet having a diameter of 14.5 mm.

It was determined where the obtained ion conductivity σ was included in any of the following evaluation standards.

In this test, in a case where the evaluation standard is “D” or higher, the ion conductivity σ is the pass level.

### Evaluation Standards

A: 1.0 ≤ σ
B: 0.9 ≤ σ < 1.0
C: 0.8 ≤ σ < 0.9
D: 0.6 ≤ σ < 0.8
E: σ < 0.6

### Evaluation 5: Cycle Characteristics

The discharge capacity retention rate of each of the all-solid state secondary batteries manufactured as described above was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the above charging and discharging cycle was repeated, and the discharge capacity of each of the all-solid state secondary batteries was measured at each time after the charging and discharging cycle was carried out with a charging and discharging evaluation device: TOSCAT-3000 (product name).

In a case where the discharge capacity (the initial discharge capacity) of the first charging and discharging cycle after initialization is set to 100%, the battery performance (the cycle characteristics) was evaluated by determining where the number of charging and discharging cycles in a case where the discharge capacity retention rate (the discharge capacity with respect to the initial discharge capacity) reaches 80% is included in any of the following evaluation standards. In this test, the higher the evaluation standard is, the better the battery performance (the cycle characteristics) is, and the initial battery performance can be maintained even in a case where a plurality of times of charging and discharging are repeated (even in a case of the long-term use). In this test, an evaluation standard of “D” or higher is the pass level.

All of the all-solid state secondary batteries according to the embodiment of the present invention exhibited initial discharge capacity values sufficient for functioning as an all-solid state secondary battery.

### Evaluation Standards

AA: 600 cycles or more
A: 500 cycles or more and less than 600 cycles
B: 300 cycles or more and less than 500 cycles
C: 150 cycles or more and less than 300 cycles
D: 80 cycles or more and less than 150 cycles
E: Less than 80 cycles

TABLE 4-1

| No. | Layer configuration | | Ion conductivity | Cycle characteristics | Note |
|---|---|---|---|---|---|
| | Electrode active material layer (sheet No.) | Solid electrolyte layer (sheet No.) | | | |
| 001 | c21 | 101 | C | B | Present invention |
| 002 | c21 | 102 | A | A | Present invention |
| 101 | 103 | c11 | C | B | Present invention |
| 102 | 104 | c11 | C | B | Present invention |
| 103 | 105 | c11 | B | C | Present invention |
| 104 | 106 | c11 | B | A | Present invention |
| 105 | 107 | c11 | B | A | Present invention |
| 106 | 108 | c11 | B | A | Present invention |
| 107 | 109 | c11 | B | A | Present invention |
| 108 | 110 | c11 | B | A | Present invention |
| 109 | 111 | c11 | B | A | Present invention |
| 110 | 112 | c11 | B | B | Present invention |
| 111 | 113 | c11 | C | B | Present invention |
| 112 | 114 | c11 | A | AA | Present invention |
| 113 | 115 | c11 | A | AA | Present invention |
| 114 | 116 | c11 | A | AA | Present invention |
| 115 | 117 | c11 | A | B | Present invention |
| 116 | 118 | c11 | A | A | Present invention |
| 117 | 119 | c11 | A | B | Present invention |

TABLE 4-2

| No. | Layer configuration | | Ion conductivity | Cycle characteristics | Note |
|---|---|---|---|---|---|
| | Electrode active material layer (sheet No.) | Solid electrolyte layer (sheet No.) | | | |
| 118 | 120 | c11 | C | B | Present invention |
| 119 | 121 | c11 | C | B | Present invention |
| 120 | 122 | c11 | B | C | Present invention |
| 121 | 123 | c11 | B | A | Present invention |
| 122 | 124 | c11 | B | A | Present invention |
| 123 | 125 | c11 | B | A | Present invention |
| 124 | 126 | c11 | B | A | Present invention |
| 125 | 127 | c11 | B | A | Present invention |
| 126 | 128 | c11 | B | A | Present invention |
| 127 | 129 | c11 | B | B | Present invention |
| 128 | 130 | c11 | C | B | Present invention |
| 129 | 131 | c11 | A | AA | Present invention |
| 130 | 132 | c11 | A | AA | Present invention |
| 131 | 133 | c11 | A | AA | Present invention |
| 132 | 134 | c11 | A | B | Present invention |
| 133 | 135 | c11 | A | A | Present invention |
| 134 | 136 | c11 | A | B | Present invention |
| c101 | c21 | c11 | E | E | Comparative Example |
| c102 | c22 | c12 | D | E | Comparative Example |
| c103 | c23 | c13 | D | E | Comparative Example |
| c104 | c24 | c14 | D | E | Comparative Example |
| c105 | c25 | c15 | D | E | Comparative Example |
| c106 | c26 | c16 | D | E | Comparative Example |
| c107 | c27 | c17 | E | D | Comparative Example |
| c108 | c28 | c18 | E | D | Comparative Example |
| c109 | c29 | c19 | D | E | Comparative Example |

The following findings can be seen from the results of Table 3 and Table 4.

All of the inorganic solid electrolyte-containing compositions KC-1 to KC-9 and NKC-1 to NKC-9, which do not contain the halogenated binder defined in the present invention, shown in Comparative Examples KC-1 to KC-9 and NKC-1 to NKC-9, are inferior in any one of the dispersibility evaluated at the solid content concentration that enables coating, or the deterioration suppressing effect or adhesiveness of the inorganic solid electrolyte of the produced sheet for an all-solid state secondary battery. In addition, the all-solid state secondary batteries of Comparative Examples c101 to c109 manufactured by using KC-1 to KC-9 and NKC-1 to NKC-9, respectively, cannot compatibly achieve cycle characteristics and ion conductivity.

On the other hand, the inorganic solid electrolyte-containing compositions that contain the halogenated binder defined in the present invention, which are shown in K-1, K-2, PK-1 to PK-17, and NK-1 to NK-17 according to the embodiment of the present invention, have both excellent dispersibility that enables uniform coating even in a case where the solid content concentration is increased, the effect of suppressing the deterioration of the inorganic solid electrolyte, and the firm adhesiveness. In addition, it can be seen that an all-solid state secondary battery including a constitutional layer formed of each of these inorganic solid electrolyte-containing compositions can realize a high ion conductivity and excellent cycle characteristics. Further, the all-solid state secondaries having the constitutional layers formed of the compositions PK-12 to PK-14 and NK-12 to NK-14 in which a particulate binder is used in combination with the halogenated binder defined in the present invention can achieve both ion conductivity and cycle characteristics at a higher level.

It is noted that the deterioration test of the above-described inorganic solid electrolyte due to watery moisture was evaluated using a sheet for an all-solid state secondary battery, which is most concerned about contact with watery moisture in an actual manufacturing process. A similar effect can be expected even in an inorganic solid electrolyte-containing composition in which the inorganic solid electrolyte and the halogenated binder defined in the present invention are present together and furthermore, in a constitutional layer incorporated into the all-solid state secondary battery, as long as they exhibit the effect of suppressing the deterioration of the inorganic solid electrolyte in the sheet for an all-solid state secondary battery.

The present invention has been described together with the embodiments of the present invention. However, the inventors of the present invention do not intend to limit of the present invention in any part of the details of the description unless otherwise designated, and it is conceived that the present invention should be broadly construed without departing from the spirit and scope of the invention shown in the attached “WHAT IS CLAIMED IS”.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: laminate for an all-solid state secondary battery
13: coin-type all-solid state secondary battery

What is claimed is:

1. An inorganic solid electrolyte-containing composition comprising:
an inorganic solid electrolyte having an ion conductivity of a metal belonging to Group 1 or Group 2 in the periodic table;
a polymer binder; and
a dispersion medium,
wherein the polymer binder includes a polymer binder consisting of a random polymer that has a halogen atom directly connected to a main chain and has a content of non-aromatic carbon-carbon double bonds of 0.01 to 10 mmol/g.

2. The inorganic solid electrolyte-containing composition according to claim 1,
wherein the halogen atom includes a fluorine atom.

3. The inorganic solid electrolyte-containing composition according to claim 1,
wherein the polymer has a constitutional component represented by Formula (VF), 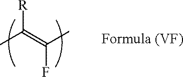
in Formula (VF), R represents a hydrogen atom or a substituent.

4. The inorganic solid electrolyte-containing composition according to claim 1,
wherein the polymer binder consisting of the random polymer contains 0.01% to 1% by mass of an organic base.

5. The inorganic solid electrolyte-containing composition according to claim 1,
wherein the random polymer has an oxygen atom or a sulfur atom, which is directly connected to the main chain.

6. The inorganic solid electrolyte-containing composition according to claim 1, further comprising an active material.

7. The inorganic solid electrolyte-containing composition according to claim 1, further comprising a conductive auxiliary agent.

8. The inorganic solid electrolyte-containing composition according to claim 1,
wherein the polymer binder includes a polymer binder other than the polymer binder consisting of the random polymer.

9. The inorganic solid electrolyte-containing composition according to claim 1,
wherein the inorganic solid electrolyte is a sulfide-based inorganic solid electrolyte.

10. A sheet for an all-solid state secondary battery, comprising a layer formed of the inorganic solid electrolyte-containing composition according to claim 1.

11. An all-solid state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the inorganic solid electrolyte-containing composition according to claim 1.

12. A manufacturing method for a sheet for an all-solid state secondary battery, the manufacturing method comprising forming a film of the inorganic solid electrolyte-containing composition according to claim 1.

13. A manufacturing method for an all-solid state secondary battery, the manufacturing method comprising manufacturing an all-solid state secondary battery through the manufacturing method according to claim 12.
